(19) United States
(12) Patent Application Publication
(10) Pub. No.: US 2004/0264809 A1
(43) Pub. Date: Dec. 30, 2004

(54) Image processing apparatus, image processing method and image processing system

(75) Inventor: Yoshiharu Uetani, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/826,390

(22) Filed: Apr. 19, 2004

(30) Foreign Application Priority Data
Apr. 21, 2003 (JP) 2003-115355
Jul. 25, 2003 (JP) 2003-202132

(51) Int. Cl. G06K 9/32; G06K 9/40

(52) U.S. Cl. 382/300; 382/260

(57) ABSTRACT

In an image processing apparatus according to an embodiment of the present invention, a first filter is inputted with first image data which includes a plurality of pixels having respective pixel values and whose number of pixels should be converted to enhance or suppress a high frequency component of the inputted first image data to generate intermediate image data. A second filter performs interpolation processing according to a linear interpolation method to the generated intermediate image data to generate second image data whose number of pixels is converted from the first image data.

### CROSS-REFERENCE TO RELATED APPLICATIONS

This application claims the benefit of priority under 35USC § 119 to Japanese Patent Application No.2003-115355, filed on Apr. 21, 2003, the entire contents of which are incorporated herein by reference herein.

This application claims the benefit of priority under 35USC § 119 to Japanese Patent Application No.2003-202132, filed on Jul. 25, 2003, the entire contents of which are incorporated herein by reference herein.

### BACKGROUND OF THE INVENTION

1. Field of the Invention

The present invention relates to an image processing apparatus, an image processing method and an image processing system, and in particular to an image processing apparatus, an image processing method and an image processing system for performing conversion of an image size (the number of pixels).

2. Background Art

Many kinds of image size conversions are required for a display function which allows enlargement/reduction at an arbitrary magnification, used in a display device such as a TV set.

Image enlargement (increase in the number of pixels) of the image size conversions is performed by interpolating a new pixel(s) between adjacent pixels. As a representative ones of the pixel interpolating methods, there are a linear interpolating method and a nearest neighbor interpolating method.

The linear interpolating method is a method which uses a value corresponding to a distance between an interpolation pixel (a pixel to be newly generated by interpolation) and a reference pixel (a pixel whose pixel value is referred to for generating the interpolation pixel) as a coefficient to perform weighted means of a plurality of reference pixels with the coefficient, thereby calculating pixel values of the interpolation pixels. On the other hand, the nearest neighbor interpolation method is a method which utilizes a pixel value of a reference pixel nearest to the position of an interpolation pixel as a pixel value of an interpolation pixel. Incidentally, the pixel value means a data value representing brightness (luminance) or tint (chrominance) of a pixel. Herein, a case that the pixel value is expressed with an integer (or number) in the range of 0 to 255 will be explained as an example.

However, these pixel interpolation methods include the following problems. In the linear interpolation method, there has been a possibility that high frequency components of the image have been lost and blur occurs in the size-converted image. On the other hand, when the nearest neighbor interpolation method has been applied to a linear image, there has been a possibility that, since a line width can not be kept constant, an edge portion is enhanced, which results in deterioration in image quality.

From these circumstances, as a pixel interpolation method for solving the above problems, a pixel interpolation method for performing switching between the linear interpolation method and the nearest neighbor interpolation method according to a distance between an interpolation pixel and a reference pixel to perform pixel interpolation has been proposed (refer to, for example, JP-A2002-209096). Here, this pixel interpolation method is called “a linear interpolation/nearest neighbor interpolation switching method” for convenience.

FIG. 32 is a diagram for representing a change of influence which an interpolation pixel receives from two reference pixels positioned on both sides thereof in the linear interpolation/nearest neighbor interpolation switching method. A horizontal axis in the diagram shows a pixel position (a phase) of an interpolation pixel to two reference pixels having pixel positions of 0.0 and 1.0, while a vertical axis shows a ratio α of an influence where the pixel value of the interpolation pixel receives from the two reference pixels. The pixel value of the interpolation pixel can be obtained by adding a multiplied result of the pixel value of the reference pixel with the pixel position of 1.0 and a value (1−α) to a multiplied result of the value α and the pixel value of the reference pixel with the pixel position of 0.0. A solid line shows a case that interpolation has been made according to the linear interpolation/nearest neighbor interpolation switching method, and a broken line shows a case that interpolation has been made according to a general linear interpolation method.

In a conventional pixel interpolation method (the linear interpolation/nearest neighbor interpolation switching method), a distance between an interpolation pixel and a reference pixel is calculated and when the distance is equal to or more than a specific threshold value, an interpolation pixel is generated according to the linear interpolation method. On the other hand, when the distance between the interpolation pixel and the reference pixel is less than the threshold value, an interpolation pixel is generated according to the nearest neighbor interpolation method.

In the case that switching between the linear interpolation method and the nearest neighbor interpolation method is performed according to the distance between the interpolation pixel and the reference pixel in this manner, when the distance between the interpolation pixel and the reference pixel is short, the pixel value of the reference pixel becomes a pixel value of the interpolation pixel according to the nearest neighbor interpolation method as it is, so that high frequency components in an image is not lost and blurring of the image can be prevented from occurring. Further, in a case that the distance between the interpolation pixel and the reference pixel is long, the linear interpolation method is applied to such a case, so that a line width does not become uneven and an edge portion is prevented from being enhanced.

In this conventional pixel interpolation method, as shown in FIG. 32, when an interpolation pixel in the vicinity of a reference pixel is generated, an interpolation pixel which is strongly influenced by a reference pixel of the two reference pixels which is positioned on a nearer side is generated as compared with application of the general linear interpolation method.

Thus, in the conventional pixel interpolation method, the pixel value of the interpolation pixel does not change linearly in proportional to its phase. For this reason, in the linear interpolation/nearest neighbor interpolation switching method, there has been a possibility that in interpolation in the vicinity of the reference pixel, an interpolation pixel according to a regularity of change in pixel value in an original image is not generated and a continuity of a pixel value of a pixel is lost.

Losing of continuity of a pixel value in the conventional pixel interpolation method will be explained with reference to FIG. 33 and FIG. 34. FIG. 33 is a diagram representing pixel values of a sample image, and FIG. 34 is a diagram representing pixel values of a size-converted image (an image obtained by converting an image size of the sample image shown in FIG. 33 to 2.5 times thereof). A horizontal axis shows, for example, pixel positions of respective pixels arranged adjacent to one another in a horizontal direction, and a vertical axis shows pixel values of respective pixels. In this connection, the pixel positions herein are represented by numbers attached to respective pixels arranged adjacent to one another in a horizontal direction in this order. Further, a pixel (displayed as A in FIG. 33) with a pixel position 5 in the sample image in FIG. 33 corresponds to a pixel (displayed as A in FIG. 34) with a pixel position 11 in the enlarged image in FIG. 34.

In pixels with pixel positions 1 to 3 of the sample image shown in FIG. 33, the pixel values of the pixels change in proportion to the pixel positions. However, when an enlargement processing is performed to the sample image according to the conventional pixel interpolation method, interpolation pixels whose pixel values do not change in proportion to the pixel positions like the pixels with the pixel positions 3 and 4 in FIG. 34 occur, so that the regularity of change of the pixel value to the pixel position becomes different from that in the sample image. This is because, when the pixel with the pixel position 2 or 4 in the sample image shown in FIG. 33 is utilized as a reference pixel and a pixel (a pixel with the pixel position 3, 4, 8 or 9 in FIG. 34) in the vicinity of the reference pixel is interpolated, the pixel value of the interpolation pixel has been strongly influenced by the pixel value of a neighboring reference pixel (the pixel with the pixel position 2 or 4 in FIG. 33).

When a pixel whose pixel value non-continuously changes from the neighboring pixel occurs due to interpolation of a pixel, the pixel is enhanced and an observer may recognize the enhanced pixel as if a contour exist therein. For convenience, hereinafter, the contour occurring falsely is called “a false contour”.

When a false contour occurs, impression different from an original image is generated on an observer, so that occurrence of a false contour causes image deterioration.

### BRIEF SUMMARY OF THE INVENTION

An image processing apparatus according to an embodiment of the present invention, comprises: a first filter which is inputted with first image data which includes a plurality of pixels having respective pixel values and whose number of pixels should be converted to enhance or suppress a high frequency component of the inputted first image data to generate intermediate image data; and a second filter which performs interpolation processing according to a linear interpolation method to the generated intermediate image data to generate second image data whose number of pixels is converted from the first image data.

An image processing method according to an embodiment of the present invention, comprises: a first processing step of being inputted with first image data which includes a plurality of pixels having respective pixel values and whose number of pixels should be converted to enhance or suppress a high frequency component of the inputted first image data to generate intermediate image data; and a second processing step of performing interpolation processing according to a linear interpolation method to the generated intermediate image data to generate second image data whose number of pixels is converted from the first image data.

An image processing system according to an embodiment of the present invention, comprises: an image data generating section which generates first image data which includes a plurality of pixels having respective pixel values and whose number of pixels should be converted; a pixel number conversion section which enhances or suppresses a high frequency component of the inputted first image data to generate intermediate image data and performs interpolation processing according to a linear interpolation method to the generated intermediate image data to generate second image data whose number of pixels is converted from the first image data.; and an image data processing section which processes the second image data.

### BRIEF DESCRIPTION OF THE DRAWINGS

FIG. 1 is a block diagram showing a configuration of an image processing apparatus according to a first embodiment of the present invention;

FIG. 2 is a circuit diagram showing a configuration of a pre-filter in the image processing apparatus according to the first embodiment of the present invention;

FIG. 3 is a diagram showing a positional relationship between a generated pixel and a original pixel in the case that an even number of taps have been formed in the pre-filter according to the first embodiment of the present invention;

FIG. 4 is a diagram showing a positional relationship between a generated pixel and a original pixel in the case that an odd number of taps have been formed in the pre-filter according to the first embodiment of the present invention;

FIG. 5 is a time chart showing an operation when the even number of taps have been formed in the pre-filter according to the first embodiment of the present invention;

FIG. 6 is a time chart showing an operation when the odd number of taps have been formed in the pre-filter according to the first embodiment of the present invention;

FIG. 7 is a diagram representing output data of the pre-filter according to the first embodiment of the present invention;

FIG. 8 is a circuit diagram showing a configuration of a linear interpolation filter in the image processing apparatus according to the first embodiment of the present invention;

FIG. 9 is a diagram showing pixel values in an image which has been subjected to an enlargement processing by the image processing apparatus according to the first embodiment of the present invention;

FIG. 10 is a flowchart showing a procedure of an image processing method according to the first embodiment of the present invention;

FIG. 11 is a block diagram showing a configuration of an image processing apparatus according to a second embodiment of the present invention;

FIG. 12 is a circuit diagram showing a configuration of a pre-filter in the image processing apparatus according to the second embodiment of the present invention;

FIG. 13 is a diagram representing output data of the pre-filter according to the second embodiment of the present invention;

FIG. 14 is a circuit diagram showing a configuration of a linear interpolation filter in the image processing apparatus according to the second embodiment of the present invention;

FIG. 15 is a diagram showing pixel values in an image which has been subjected to an enlargement processing by the image processing apparatus according to the second embodiment of the present invention;

FIG. 16 is a flowchart showing a procedure of an image processing method according to the second embodiment of the present invention;

FIG. 17 is a block diagram showing a configuration of an image processing apparatus according to a third embodiment of the present invention;

FIG. 18 is a circuit diagram showing a configuration of a pre-filter in the image processing apparatus according to the third embodiment of the present invention;

FIG. 19 is a circuit diagram showing a configuration of a linear interpolation filter in the image processing apparatus according to the third embodiment of the present invention;

FIG. 20 is a flowchart showing a procedure of an image processing method according to the third embodiment of the present invention;

FIG. 21 is a block diagram showing a configuration of an image processing apparatus according to a fourth embodiment of the present invention;

FIG. 22 is a diagram representing pixel values in a sample image;

FIG. 23 is a diagram representing output data of a pre-filter according to the fourth embodiment of the present invention;

FIG. 24 is a circuit diagram showing a configuration of a pixel value allowable range determination circuit in the image processing apparatus according to the fourth embodiment of the present invention;

FIG. 25 is a circuit diagram showing a configuration of a linear interpolation filter in the image processing apparatus according to the fourth embodiment of the present invention;

FIG. 26 is a diagram representing pixel values in an image which has been subjected to an enlargement processing by the image processing apparatus according to the fourth embodiment of the present invention;

FIG. 27 is a flowchart showing a procedure of an image processing method according to the fourth embodiment of the present invention;

FIG. 28 is a diagram showing an MPEG2 encoding apparatus (an image compressing apparatus) according to a fifth embodiment of the present invention;

FIG. 29 is a diagram showing an MPEG2 decoding apparatus (a compressed image elongating apparatus) according to a sixth embodiment of the present invention;

FIG. 30 is a diagram showing an MPEG2 encoding rate converting apparatus (an image re-compressing apparatus) according to a seventh embodiment of the present invention;

FIG. 31 is a diagram showing a TV system having a multi-screen displaying function according to an eighth embodiment of the present invention;

FIG. 32 is a diagram representing a change of an influence which an interpolation pixel receives from two reference pixels positioned on both sides of the interpolation pixel in a conventional pixel interpolation method;

FIG. 33 is a diagram representing pixel values in a sample image; and

FIG. 34 is a diagram representing pixel values in an image obtained by converting an image size of the sample image shown in FIG. 33 to 2.5 times in the conventional pixel interpolation method.

### DETAILED DESCRIPTION OF THE INVENTION

(First Embodiment)

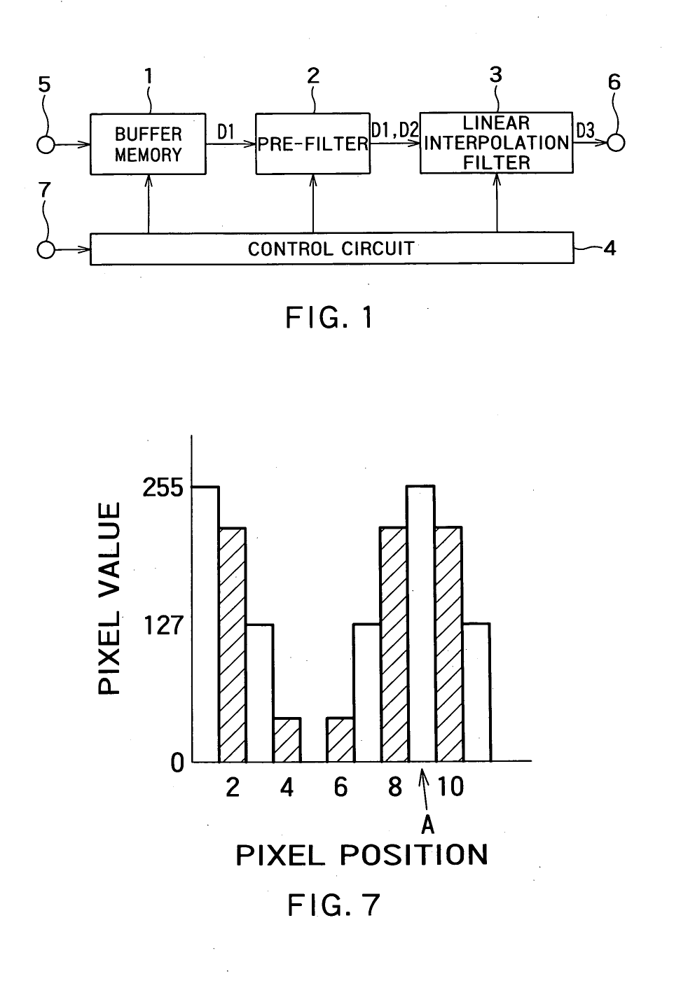

A first embodiment regarding an image processing apparatus and an image processing method according to the present invention will be explained below with reference to FIGS. 1 to 10. In the following, a case where a size conversion to an original image (an image before size conversion) is made in a horizontal direction will be explained as an example.

First, an image processing apparatus according to this embodiment will be explained with reference to FIGS. 1 to 9. FIG. 1 is a block diagram showing a configuration of an image processing apparatus according to this embodiment.

As shown in FIG. 1, the image processing apparatus according to this embodiment is provided with a buffer memory 1, a pre-filter 2 which is a first filter, a linear interpolation filter 3 which is a second filter, and a control circuit 4.

The buffer memory 1 is a memory for temporarily storing an image data string inputted from an input terminal 5. The buffer memory 1 outputs the image data string to the pre-filter 2 which is a rear stage according to a control signal inputted from the control circuit 4. The image data string means pixel values of pixels whose pixel positions are adjacent to one another, which have been arranged in a direction of size conversion in an image. Therefore, when size conversion is performed on an original image in a horizontal direction, the image data string forms pixel values of pixels whose pixel positions are adjacent to one another, which are arranged in a horizontal direction in an image. Here, the image data string inputted in the buffer memory 1 indicates pixel values D1 of original pixels (pixels constituting the original image) whose pixel positions are adjacent to one another in a horizontal direction in the original image. Furthermore, the pixel value is a data value representing brightness (luminance) or tint (chrominance) of a pixel. In the following, a case that the pixel value is represented by a real number in the range of 0 to 255 will be explained as an example.

The pre-filter 2 calculates a pixel value D2 of a generated pixel (a pixel newly generated by the pre-filter 2) which has been subjected to a high-frequency correction in the case of enlargement processing on the basis of the image data string inputted from the buffer memory 1 and calculates a pixel value D2 of a generated pixel which has been subjected to a high-frequency restriction in the case of a reduction processing.

The linear interpolation filter 3 is inputted with the pixel value D1 of the original pixel (the pixel inputted into the pre-filter 2) and the pixel value D2 of the generated pixel from the pre-filter 2, and calculates a pixel value D3 of an interpolation pixel (a pixel which is generated by interpolation) according to a linear interpolation method utilizing the original pixel and the generated pixel as reference pixels (pixels whose pixel values are referenced for generating an interpolation pixel) at the time of enlargement processing and calculates the pixel value D3 of an interpolation pixel according to the linear interpolation method utilizing two adjacent generated pixels as the reference pixels at the time of reduction processing. The pixel value D3 of the interpolation pixel is outputted to an output terminal 6.

The control circuit 4 controls operations the buffer memory 1, the pre-filter 2 and the linear interpolation filter 3 according to a pixel number conversion ratio (the number of pixels of an image after size conversion/the number of pixels of an image before size conversion). The pixel number conversion ratio is designated by a control parameter inputted from an input terminal 7.

With the configuration explained above, the pixel values D3 of the interpolation pixels are outputted from the output terminal 6 in the order of their pixel positions. The pixel values D3 of the interpolation pixels outputted in the order of the pixel positions correspond to pixel values of pixels whose pixel positions are adjacent to one another, which are arranged in a horizontal direction in an image subjected to size conversion. That is, an image data string of the original image inputted from the input terminal 5 is converted to an image data string in an image subjected to the size conversion to be outputted from the output terminal 6.

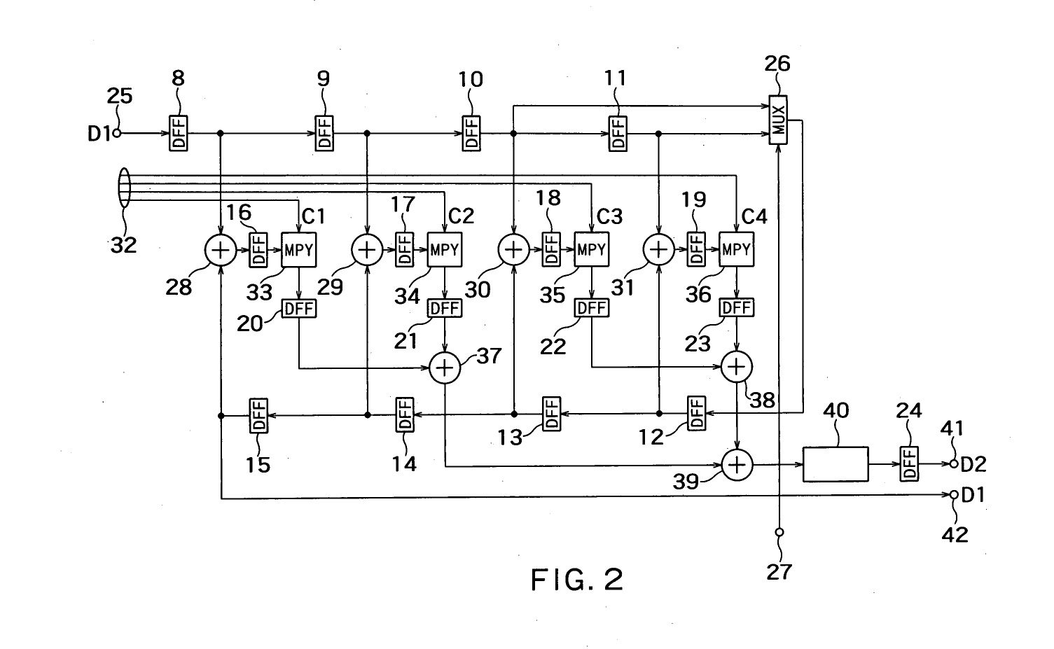

Next, a specific constitution of the pre-filter 2 will be explained with reference to FIG. 2.

FIG. 2 is a circuit diagram showing a constitution of the pre-filter 2 in the image processing apparatus according to this embodiment.

Registers 8 to 24 are D type flip-flops with Enable, and holding and updating of output data of each flip-flop is controlled by controlling the enable by the control circuit 4.

Further, the registers 8 to 15 of these registers constitute delay circuits corresponding to the number of taps (the number of original pixels referenced in calculation of the pixel values D2 of generated pixels) and they delay the pixel values D1 of the original pixels inputted from the input terminal 25 sequentially to output them through the output terminal 42 finally.

A selector 26 is inputted with a control signal from the control circuit 4 through an input terminal 27 and makes control about whether the number of taps should be set to an even number of taps or an odd number of taps on the control signal. The selector 26 selects output data of the register 11 so that the even number of taps are formed, while it selects output data of the register 10 so that the pixel values of the same pixel are outputted from the registers 11 and 12 and the odd number of taps are formed.

Adders 28 to 31 add the pixel values D1 of the original pixels at tap positions where the filter coefficient are the same. Further, filter coefficients C1, C2, C3 and C4 to respective tap positions are inputted in an input terminal 32 from the control circuit 4, and the addition results of the adders 28 to 31 are multiplied with filter coefficients in multipliers 33 to 36 so that the total sums of the multiplication results are calculated in adders 37 to 39. Here, operation performed by the filter coefficients and the image data string such as the above is called “a convolution operation”.

An amplitude restricting unit 40 rounds the total sum of the multiplication results outputted from the adder 39, and further restricts it within the maximum amplitude (0 to 255) to output the same to an output terminal 41 through the register 24. Then, the pixel value outputted from the output terminal 41 becomes a pixel value D2 of a generated pixel newly generated.

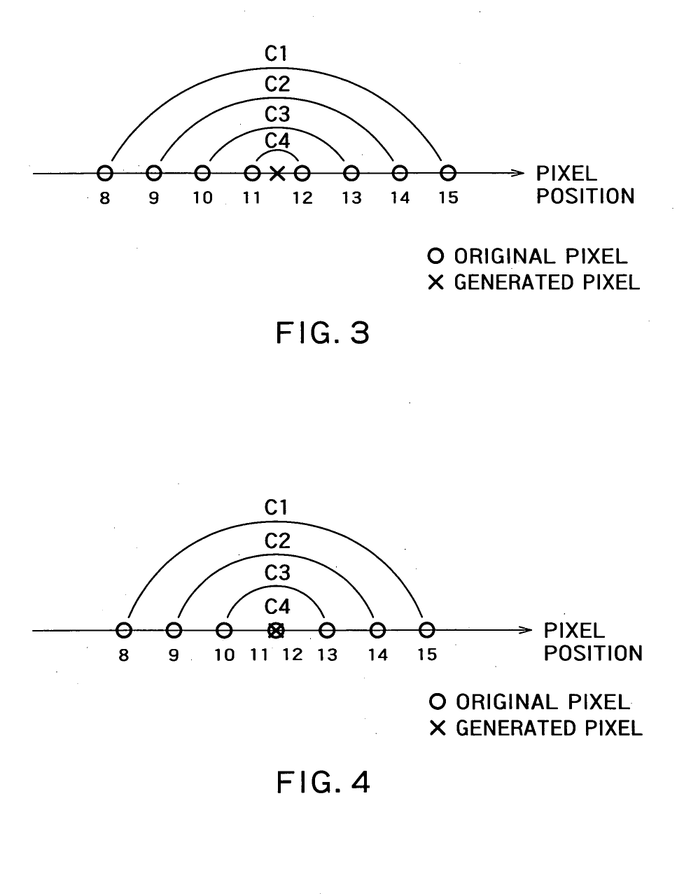

The pixel position of the generated pixel varies according to whether the number of taps is set to an even number of taps or an odd number of taps by the selector 26. This will be explained below with reference to FIG. 3 and FIG. 4. FIG. 3 shows a positional relationship between a generated pixel and original pixels when the even number of tap has been formed, and FIG. 4 shows a positional relationship between a generated pixel and original pixels when the odd number of taps has been formed. Here, reference numeral attached below each original pixel in the figures indicates the reference numeral attached to the register where the pixel value of the original pixel has been held, and a line connecting two original pixels shows that the pixel values of the original pixels connected by the line are multiplied with the same filter coefficient in the convolution operation. For example, two original pixels whose pixel values have been held in the registers 8 and 15 are multiplied with the same filter coefficient C1 and two original pixels whose pixel values have been held in the registers 9 and 14 are multiplied with the same filter coefficient C2.

When the even number of taps are formed, as shown in FIG. 3, original pixels are positioned symmetrically centering an intermediate portion of two original pixels whose pixel values have been held at the outputs of the registers 11 and 12. Since the original pixels positioned symmetrically are multiplied with the same filter coefficient, the pixel position of the generated pixel generated according to the convolution operation becomes an intermediate position between the two original pixels whose pixel values have been held at the outputs of the registers 11 and 12. On the other hand, when the odd number of taps are formed, as shown in FIG. 4, other original pixels are positioned symmetrically centering the original pixels whose pixel values have been held at the outputs of the registers 11 and 12. Since the original pixels positioned symmetrically are multiplied with the same filter coefficient, the pixel position of a generated pixel generated according to the convolution operation becomes the same pixel position as the position of a central original pixel.

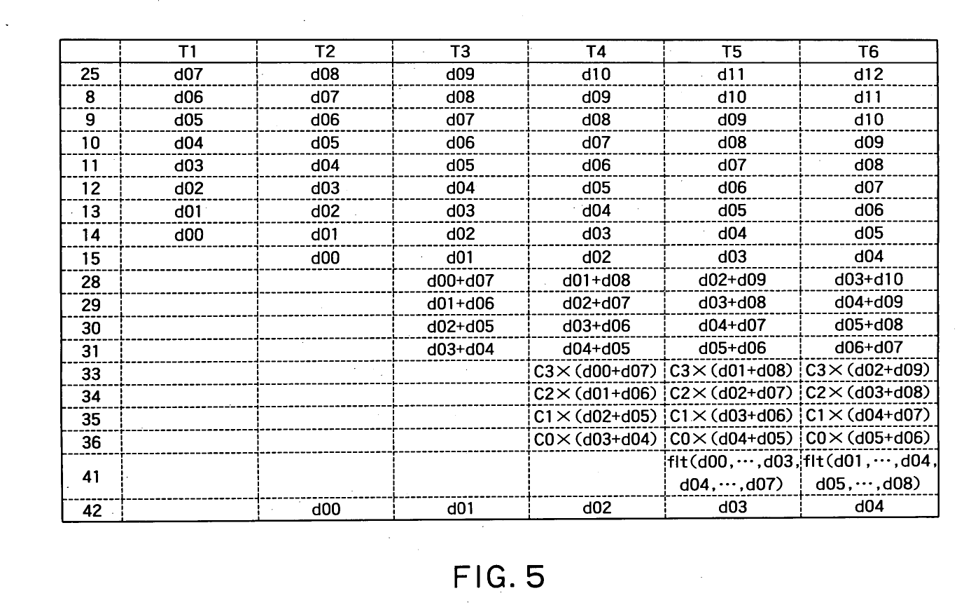

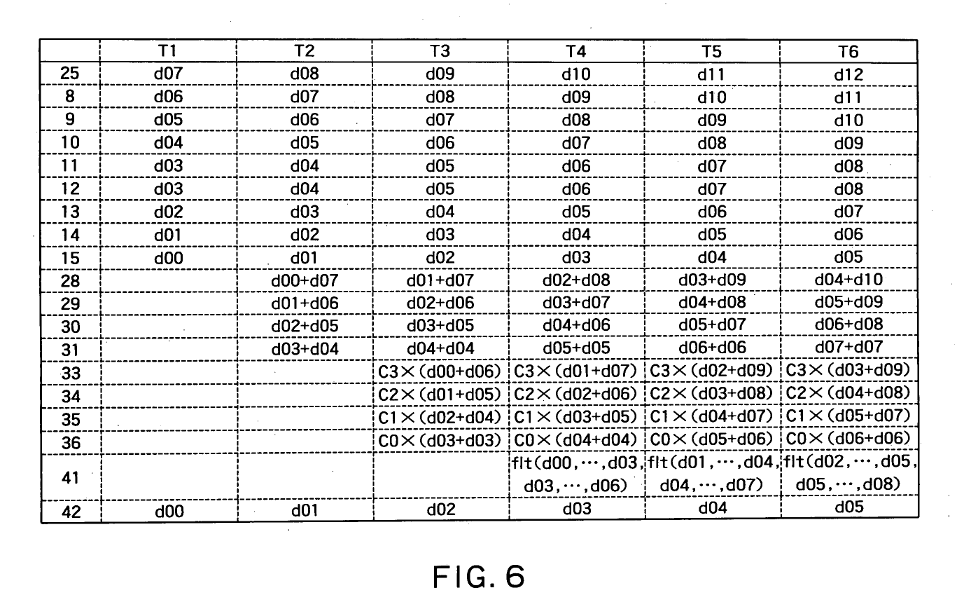

Next, a positional relationship between generated pixels whose pixel values are outputted from the output terminal 41 and original pixels whose pixel values are outputted from the output terminal 42 will be explained with reference to FIGS. 5 and 6. FIG. 5 is a time chart showing operation of the pre-filter 2 when an even number of taps have been formed, and FIG. 6 is a time chart showing operation of the pre-filter 2 when the odd number of taps have been formed. FIGS. 5 and 6 show values of data inputted in the input terminal 25, the registers 8 to 15, the adders 28 to 31, the multipliers 33 to 36 and the output terminals 41 and 42 at respective times from time T1 to time T6.

Further, d00 to d15 indicate pixel values D1 of original pixels which are adjacent to one another in a horizontal direction in an original image, and they are inputted from the input terminal 25 in a time period from the time T1 to the time T6 in the order of pixel positions. Further, the pixel values D2 of generated pixels outputted from the output terminal 41 are expressed by a function. For example, fit (d00, . . . , d03, d04, . . . , d07) shows a value obtained by performing convolution operation using original pixels d00 to d07, and fit (d01, . . . , d04, d05, . . . , d08) shows a value obtained by performing convolution operation using original pixels d01 to d08.

First, the positional relationship between generated pixels whose pixel values are outputted from the output terminal 41 and the original pixels whose pixel values are outputted from the output terminal 42 when the even number of taps have been formed will be explained with reference to FIG. 5. At a time T5, data fit (d00, . . . , d03, d04, . . . , d07) is outputted from the output terminal 41, and the pixel value d03 of the original pixel is outputted from the output terminal 42. When the even number of taps are formed, a pixel position of a generated pixel generated according to the convolution operation becomes an intermediate position between two original pixels whose pixel values have been held at the outputs of the registers 11 and 12. That is, when a convolution operation is performed using the original pixels of d00 to d07, the operation result obtained becomes a pixel value of a generated pixel positioned between the original pixel d03 and the original pixel d04. For this reason, the generated pixel whose pixel value is outputted from the output terminal 41 at the time T5 is eventually positioned after 0.5 pixel from the original pixel whose pixel value is outputted from the output terminal 42. The positional relationship between a generated pixel whose pixel value is outputted from the output terminal 41 and a original pixel whose pixel value is outputted from the output terminal 42 is similar to that even at another time.

Next, a positional relationship between a generated pixel whose pixel value is outputted from the output terminal 41 and a original pixel whose pixel value is outputted from the output terminal 42 when an odd number of taps have been formed will be explained with reference to FIG. 6. At a time T4, data fit (d00, . . . , d03, d03, . . . , d06) is outputted from the output terminal 41, and a pixel value d03 of a original pixel is outputted from the output terminal 42. When the odd number of taps is formed, a pixel position of a generated pixel generated according to the convolution operation becomes the same pixel position as a central original pixel. That is, when the convolution operation is performed using original pixels of d00 to d06, the operation result obtained becomes a pixel value of a generated pixel positioned at the same position as the original pixel d03. For this reason, the generated pixel whose pixel value is outputted from the output terminal 41 at the time T4 is positioned at the same pixel position as the original pixel whose pixel value is outputted from the output terminal 42. A positional relationship between a generated pixel whose pixel value is outputted from the output terminal 41 and a original pixel whose pixel value is outputted from the output terminal 42 is similar to that even at another time.

Thus, regarding the positional relationship between the generated pixel whose pixel value is outputted from the output terminal 41 and the original pixel whose pixel value is outputted from the output terminal 42, the original pixel is positioned before 0.5 pixel from the generated pixel at the formation time of the even number of taps, and the original pixel and the generated pixel are positioned at the same pixel position at the formation time of the odd number of taps.

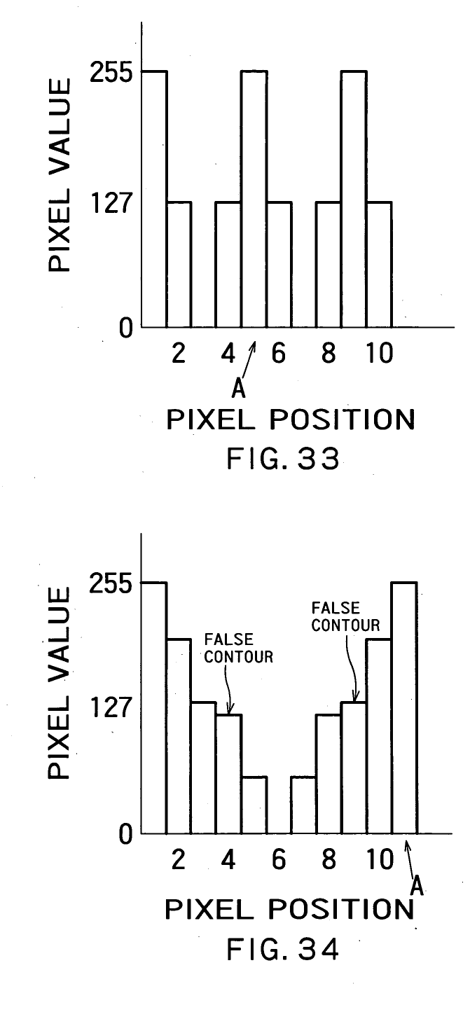

When an enlargement processing is performed, the pixel position of the generated pixel is set at an intermediate position between the original pixels by forming an even number of taps, and a doubling processing of the number of pixels is performed by interpolating a generated pixel between the original pixels. Then, the filter coefficients C1, C2, C3 and C4 are set such that a high frequency component of an image data string is enhanced according to its frequency characteristics by the interpolation of the generated pixel. A graph representing pixel values in an image obtained by performing interpolation with a generated pixel on the sample image shown in FIG. 33 is shown in FIG. 7. A horizontal axis shows, for example, pixel positions of respective pixels arranged adjacent to one another in a horizontal direction, and a vertical axis shows pixel values of respective pixels. Further, a pixel (indicated with A in FIG. 33) of the pixel position 5 in the sample image shown in FIG. 33 corresponds to a pixel (indicated with A in FIG. 7) of the pixel position 9 in the image interpolated with the generated pixel in FIG. 7. Incidentally, here, the pixel positions are attached with numbers in the order to respective pixels of an image obtained after interpolation with a generated pixel, which are arranged adjacent to one another in a horizontal direction. Further, portions attached with slanting lines show generated pixels interpolated between original pixels, and portions with no slanting line show original pixels. The generated pixel is interpolated between original pixels so that the number of pixels is doubled and a high frequency component is further enhanced. As described above, making the pixel value D2 of the generated pixel to a value which enhances a high frequency component of an image data string by performing interpolation between original pixels is called “a high-frequency correction”, and generating a generated pixel which has been subjected to a high-frequency correction is called “a high-frequency correcting processing”.

On the other hand, when a reduction processing is performed, either of the even number of taps and the odd number of taps may be formed. In the case of the latter case, pixel values D2 of generated pixels outputted from the output terminal 41 constitute a new image data string different from the image data string due to original pixels. Then, the filter coefficients C1, C2, C3 and C4 are set such that the new image data string due to the generated pixels suppresses a high frequency component of the image data string obtained by the original pixels. As described above, making the pixel value D2 of the generated pixel to a value which constitutes a novel image data string whose high frequency component has been suppressed more than the image data string obtained by the original pixels is called “a high-frequency restriction”, and generating a generated pixel which has been subjected to the high-frequency restriction is called “a high-frequency restricting processing”.

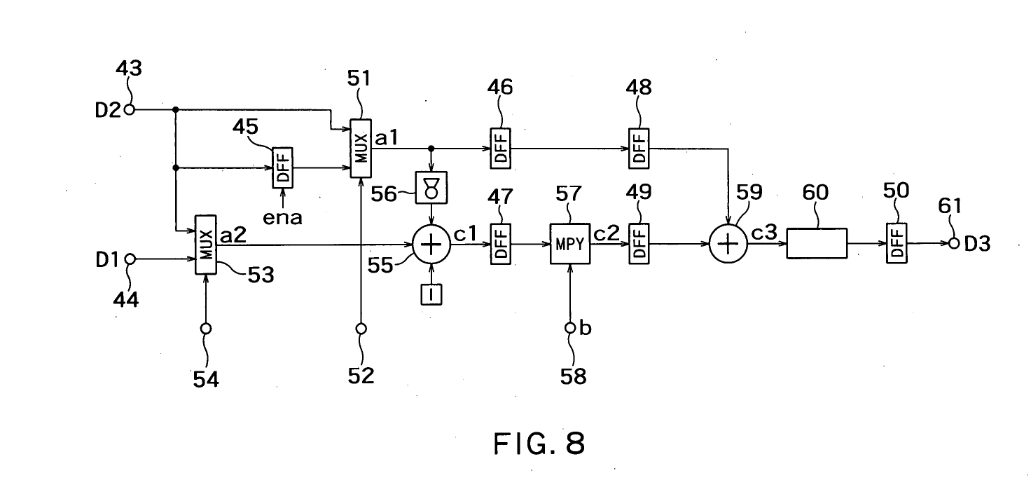

Next, a specific configuration of the linear interpolation filter 3 will be explained with reference to FIG. 8. FIG. 8 is a circuit diagram showing a configuration of the linear interpolation filter 3 in the image processing apparatus according to this embodiment.

The pixel values D2 of generated pixels outputted from the output terminal 41 of the filter 2 are inputted into an input terminal 43. Further, pixel values D1 of original pixels outputted from the output terminal 42 of the pre-filter 2 are inputted into an input terminal 44.

The register 45 is a D type flip-flop with Enable and its Enable is controlled by the control circuit 4 so that a pixel value D2 of a generated pixel inputted before one pixel to another generated pixel inputted from the input terminal 43 is held at its output.

Registers 46 to 50 are D type flip-flops for updating output data for each clock.

A selector 51 is inputted with a control signal from the control circuit 4 via the input terminal 52, and it selects either one of a pixel value D2 of a generated pixel inputted from the input terminal 43 and output data of the register 45 on the basis of the control signal to output the same. The selector 51 selects, for example, the output data of the register 45 in the case of a reduction processing. On the other hand, in the case of an enlargement processing, when interpolation of a pixel position before a original pixel inputted from the input terminal 44 is performed, the selector 51 selects output data of the register 45 (a pixel value of a generated pixel positioned before 0.5 pixel from the original pixel), and when interpolation of a pixel position after the original pixel is performed, the selector 51 selects a pixel value D2 of a generated pixel inputted from the input terminal 43 (a pixel value of a generated pixel positioned after 0.5 pixel from the original pixel).

A selector 53 is inputted with a control signal from the control circuit 4 via the input terminal 54, and it selects and outputs either one of a pixel value D2 of a generated pixel inputted from the input terminal 43 and a pixel value D1 of a original pixel inputted from the input terminal 44 on the basis of the control signal. In the case of a reduction processing, for example, the selector 53 selects the pixel value D2 of the generated pixel inputted from the input terminal 43, and it selects a pixel value D1 of a original pixel inputted from the input terminal 44 in the case of an enlargement processing.

An adder 55 adds a complement pixel value generated by bit-inverting output data a1 of the selector 51 in an inverter 56, output data a2 of the selector 53 and a value 1 to calculate a difference c1(=a2−a1) between the output data a2 of the selector 53 and the output data a1 of the selector 51.

A multiplier 57 is inputted with a multiplication coefficient b corresponding to the phase of an interpolation pixel from the control circuit 4 via an input terminal 58, and it calculates a multiplication result c2(=b×(a2−a1)). Here, the phase of an interpolation pixel indicates distances from the pixel positions of two reference pixels (pixels having pixel values a1 and a2) to the pixel position of the interpolation pixel.

An adder 59 is inputted with the multiplication result c2(=b×(a2−a1)) and the output data a1 of the selector 51 via the registers 49 and 48, and it calculates an operation result c3(=a1+b×(a2−a1)). When the operation result c3(=a1+b×(a2−a1)) is expressed in another manner, it is expressed as (a1×(1−b)+a2×b). A linear interpolation data corresponding to the phase of the interpolation pixel is generated according to this operation.

A rounding unit 60 rounds the linear interpolation data to output the same via the register 50 and an output terminal 61. The output data becomes the pixel value D3 of the interpolation pixel constituting image data which has been subjected to a size conversion.

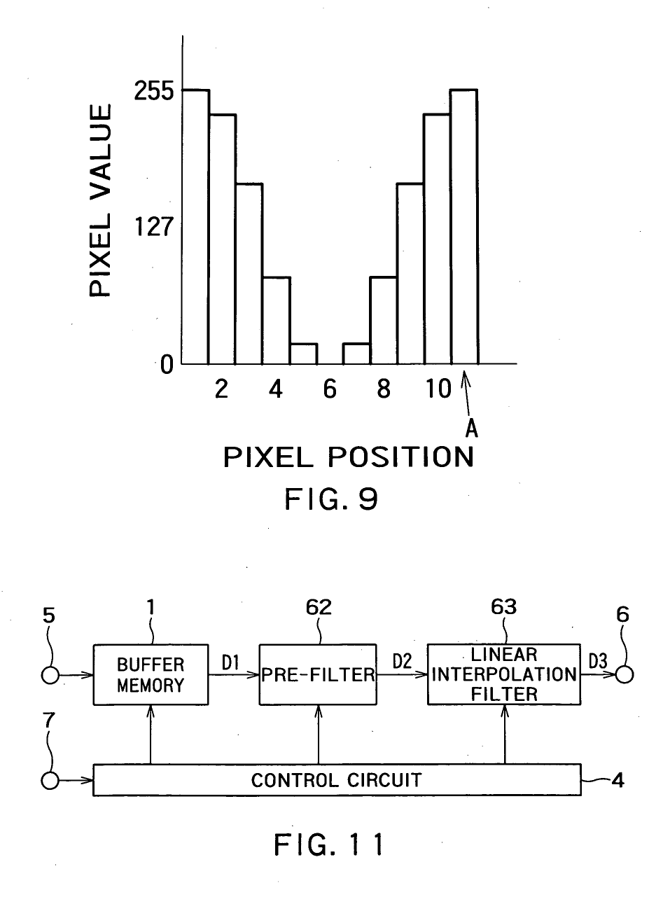

A graph representing pixel values of an image where the number of pixels on the sample image shown in FIG. 33 has been enlargement-processed to 2.5 times according to the image processing apparatus according to this embodiment is shown in FIG. 9. In FIG. 9, a horizontal axis shows, for example, pixel positions of respective pixels arranged adjacent to one another in a horizontal direction, and a vertical axis shows pixel values of the respective pixels. Further, a pixel (displayed as A in FIG. 33) at a pixel position 5 in the sample image shown in FIG. 33 corresponds to the pixel (displayed as A in FIG. 9) at a pixel position 11 in the image which has been subjected to the enlargement processing in FIG. 9. Incidentally, the pixel position here is indicated by one of serial numbers attached to respective pixels arranged adjacent to one another in a horizontal direction in an image which has been subjected to an enlargement processing. In the image which has been subjected to an enlargement processing by the image processing apparatus according to this embodiment, its high frequency component is not lost even by the enlargement processing and a false contour due to non-continuous change of pixel values of pixels does not occur, which is different from an image which has been subjected to an enlargement processing by the conventional linear interpolation/nearest neighbor interpolation switching method shown in FIG. 34.

As described above, in the enlargement processing of an image, the image processing apparatus according to this embodiment generates a generated pixel which is positioned in an intermediate position between adjacent original pixels and which has been subjected to a high-frequency correction to perform pixel interpolation by the linear interpolation method utilizing the generated pixel with a high-frequency correction and the original pixels as reference pixels. Thus, since the image processing apparatus according to this embodiment enhances a high frequency component of an image before linear interpolation, even if pixel interpolation is performed by the linear interpolation method, the high frequency component in the image is not lost and blurring of an image can be prevented from occurring due to loss of the high frequency component.

Further, the image processing apparatus according to this embodiment adopts the linear interpolation method as the pixel interpolation method, where the degree of influence of the reference pixel to the pixel value D3 of the interpolation pixel is proportional to the phase of the interpolation pixel. For this reason, a false contour is prevented from occurring unlike the case that pixel interpolation has been performed by the conventional linear interpolation/nearest neighbor interpolation switching method.

Further, in general, when a reduction processing is performed on an image with a strong high frequency component, an image which gives an impression different from that of an original image may occur. However, the image processing apparatus according to this embodiment suppresses a high frequency component in an image by generating a generated pixel with a restricted high frequency in a reduction processing. Therefore, a more natural image can be obtained in the reduction processing.

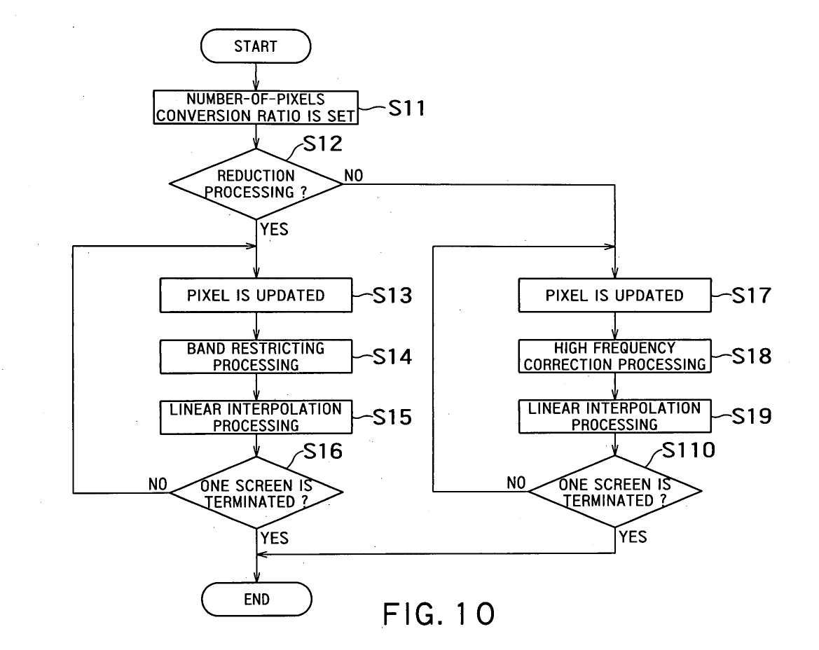

Next, the image processing method according to this embodiment will be explained with FIG. 10.

FIG. 10 is a flowchart showing a procedure of the image processing method according to this embodiment.

First, a number-of-pixels conversion ratio is set (Step S11). Then, determination is made on the basis of the number-of-pixels conversion ratio set in Step S11 about whether or not an image size conversion processing is a reduction processing (S12).

When affirmative determination is made in Step S12, an image data string stored in the buffer memory 1 is updated (S13) and a band restricting processing is performed using pixel values D1 of original pixels read out from the buffer memory 1 so that pixel values D2 of generated pixels with a restricted band are calculated (S14). Next, a linear interpolation processing is performed using the pixel values D2 of the generated pixels with a restricted band, so that pixel values D3 of interpolation pixels are calculated by the linear interpolation method (S15). After the linear interpolation processing has been terminated, determination is made whether or not a processing of pixels corresponding to one screen has been terminated. When negative determination is made, the control returns back to Step S13, where the above-described Steps S13 to S15 are repeated until the processing for the one screen has been terminated (S16).

On the other hand, when negative determination is made in Step S12 (when determination is made that the processing to be performed is an enlargement processing), the image data string stored in the buffer memory 1 is updated (S17), and a high-frequency correcting processing is performed using the pixel values D1 of the original pixels read out from the buffer memory 1 so that pixel values D2 of generated pixels with a corrected high frequency are calculated (S18). Interpolation between the original pixels is made with the generated pixel according to the high-frequency correcting processing so that a doubling processing for the number of pixels is performed. Next, a linear interpolation processing is performed using the pixel values D1 of the original pixels and the pixel values D2 of the generated pixels with a corrected high frequency so that pixel values D3 of interpolation pixels are calculated (S19). After the linear interpolation processing has been terminated, determination is made whether or not a processing of pixels corresponding to one screen has been terminated. When negative determination is made, the control returns back to Step S17, where the above-described Steps S17 to S19 are repeated until the processing for the one screen has been terminated (S110).

The image processing method according to this embodiment explained above generates generated pixels with an enhanced high frequency which is positioned at an intermediate position between adjacent original pixels in the enlargement processing of an image to perform pixel interpolation by the linear interpolation method using the generated pixels with an enhanced high frequency and the original pixels as the reference pixels. Thus, since the image processing method according to this embodiment enhances a high frequency component in an image before the linear interpolation is performed, even if pixel interpolation is performed by the linear interpolation method, the high frequency component in the image is not lost and blurring of the image can be prevented from occurring due to loss of the high frequency component.

Further, since the image processing method according to this embodiment adopts the linear interpolation method for the pixel interpolation method, where the pixel value D3 of the interpolation pixel is linearly proportional to the phase of the interpolation pixel. For this reason, a false contour is prevented from occurring unlike the case that pixel interpolation has been performed by the conventional linear interpolation/nearest neighbor interpolation switching method.

Furthermore, the image processing method according to this embodiment suppresses a high frequency component in an image by generating a generated pixel which has been subjected to a high-frequency restriction in the reduction processing. Therefore, a more natural image can be obtained in the reduction processing.

Incidentally, in explanation of the image processing apparatus according to this embodiment, the specific circuit configurations of the pre-filter 2 and the linear interpolation filter 3 have been shown, but circuit configurations of these filters are not limited to these specific configurations. For example, pre-filter 2 may determine the number of original pixels which is referenced for a convolution operation according to a control parameter (for example a pixel number conversion ratio) from the control circuit 4. In addition, the image processing apparatus according to this embodiment performs the linear interpolation using two pixels as reference pixels, but this invention is not limited to this linear interpolation. In this invention, a linear interpolation may be performed using three or more pixels as reference pixels.

Moreover, the respective constituent elements of the image processing apparatus according to this embodiment (the buffer memory 1, the pre-filter 2, the linear interpolation filter 3 and the control circuit 4) may be all provided on the same semiconductor chip, some or all of these elements may be provided independently from other constituent element (constituent elements other than the above-described respective constituent elements).

Furthermore, in the image processing apparatus and the image processing method according to this embodiment, such a constitution is employed that a generated pixel is interpolated between original pixels by the high-frequency correcting processing so that the number of pixels is doubled, but the increase rate in number of pixels is not limited to the double. For example, after the number of pixels has been doubled, and the number of pixels may be quadrupled by inputting an image data string whose number of pixels has been doubled into the pre-filter 2 again.

In the image processing apparatus and the image processing method according to this embodiment, also, the linear interpolation is performed in the reduction processing, but the linear interpolation is not an essential processing for this invention. An advantage similar to the case that a linear interpolation has been performed can be obtained even by extracting generated pixels which have been subjected to a high-frequency restriction at constant intervals to constitute a new image without performing a linear interpolation.

Further, in the image processing apparatus and the image processing method according to this embodiment, the case that the size conversion of an image in the horizontal direction is performed as one example has been explained, but this invention is not limited to this case. A similar advantage to the case that the size conversion in the horizontal direction has been performed can be obtained even in the case that a size conversion is performed in such another direction as a vertical direction.

In the image processing apparatus and the image processing method according to this embodiment, also, only the explanation about the size conversion in an one-dimensional direction (a horizontal direction) has been made. However, for example, size conversion in a two-dimensional direction can be performed by, after performing a size conversion in a horizontal direction, performing a similar size conversion to a vertical direction utilizing the image which has been subjected to the size conversion in the horizontal direction as an original image. In this connection, such a constitution can be employed that, after a size conversion corresponding to one screen in one direction of a horizontal direction and a vertical direction has been terminated, a size conversion in the other direction is performed, or a size conversion corresponding to one screen is performed by extracting an image occupying a rectangular region of predetermined size and performing size conversion of the extracted image in a horizontal direction and in a vertical direction, and repeating extraction and size conversion of such an image.

(Second Embodiment)

A second embodiment about an image processing apparatus and an image processing method according to the invention will be explained with reference to FIGS. 11 to 16.

First, the image processing apparatus according to this embodiment will be explained with reference to FIGS. 11 to 15.

FIG. 11 is a block diagram showing a configuration of the image processing apparatus according to this embodiment.

In this connection, parts and/or portions common to those in the first embodiments explained with reference to FIG. 1 are attached with same reference numerals in FIG. 1, and explanation thereof will be omitted. As shown in FIG. 11, the image processing apparatus according to this embodiment is provided with a buffer memory 1, a pre-filter 62 which is a first filter, a linear interpolation filter 63 which is a second filter, and a control circuit 4.

The pre-filter 62 calculates pixel values D2 of generated pixels which have been subjected to a high-frequency enhancement in the case of an enlargement processing and it calculates pixel values D2 of generated pixels which have been subjected to a high-frequency restriction in the case of a reduction processing on the basis of the image data string inputted from the buffer memory 1.

The linear interpolation filter 63 is inputted with the pixel values D2 of the generated pixels from the pre-filter 62 and a pixel value D3 of interpolation pixel is calculated by a linear interpolation method utilizing two adjacent generated pixels as reference pixels. The pixel values D3 of the interpolation pixel is outputted to an output terminal 6.

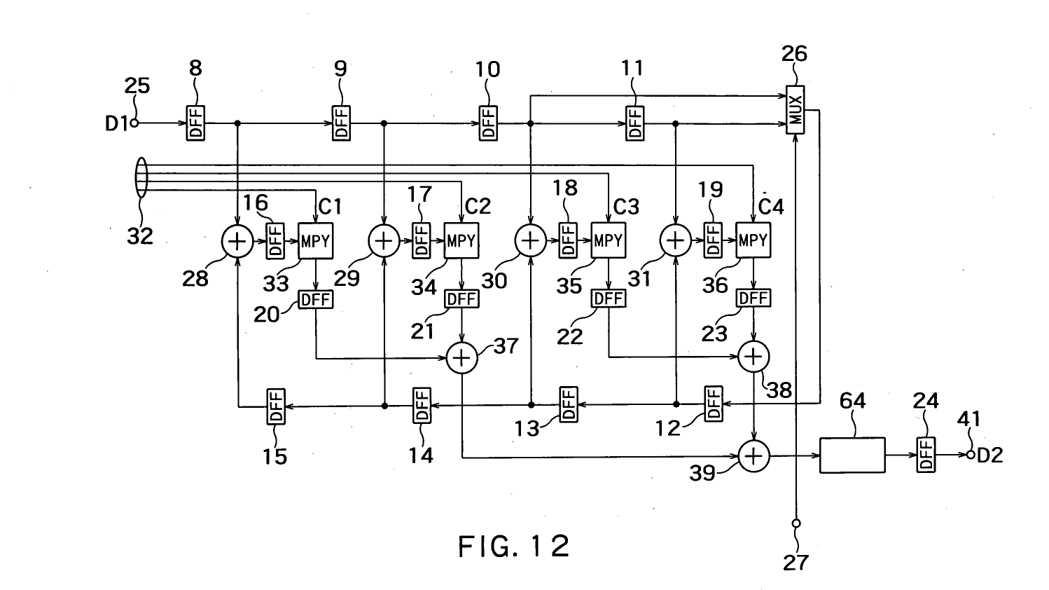

Next, a specific configuration of the pre-filter 62 in the image processing apparatus according to this embodiment will be explained with reference to FIG. 12. FIG. 12 is a circuit diagram showing a configuration of the pre-filter 62 in the image processing apparatus according to this embodiment. Incidentally, parts or portions common to those in the first embodiment explained with reference to FIG. 2 are attached with same reference numerals as those in FIG. 2, and explanation thereof will be omitted.

A selector 26 is for performing control about whether the number of taps is made even or it is made odd. When an even number of taps are formed by selecting the output data of the register 11, and the same pixel value is outputted from the registers 11 and 12 by selecting the output data of the register 10 so that the odd number of taps is formed. In this embodiment, either of an even number of taps and an odd number of taps can be formed in both the enlargement processing and the reduction processing.

A rounding unit 64 performs rounding on the result of a convolution operation outputted from the adder 39 to output the same to an output terminal 41 via the register 24 without limitation within the maximum amplitude (0 to 255).

Then, data outputted from the output terminal 41 becomes pixel values D2 of generated pixels constituting another new image data string different from the image data string based on the original pixels.

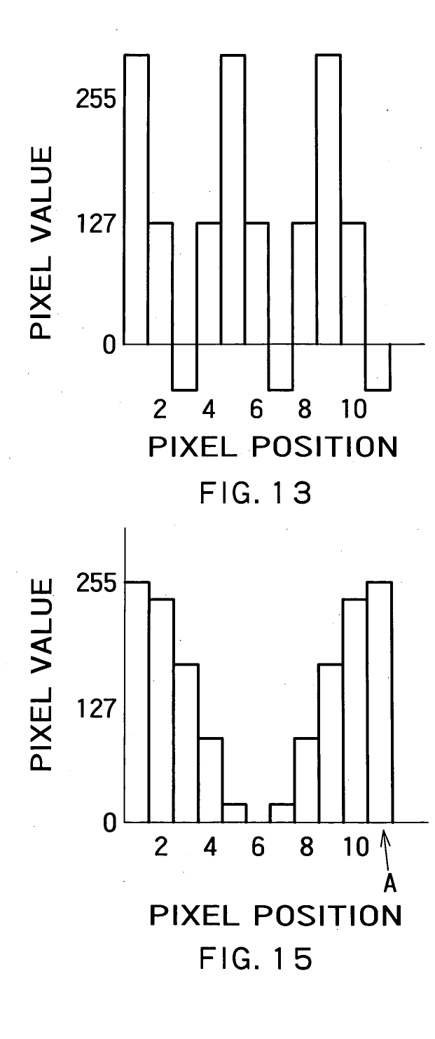

Here, the filter coefficients C1, C2, C3 and C4 are set such that the new image data string obtained by the generated pixels becomes an image data string obtained by the original pixels, whose high frequency component has been enhanced, in the case of an enlargement processing. A graph representing pixel values of generated pixels calculated using the above filter coefficients on the basis of the sample image shown in FIG. 33 is shown in FIG. 13. A horizontal axis shows, for example, pixel positions of respective pixels arranged adjacent to one another in a horizontal direction and a vertical axis shows pixel values of the respective pixels. Incidentally, the pixel position here is indicated by one of serial numbers attached to respective pixels arranged adjacent to one another in a horizontal direction in an image comprising generated pixels.

FIG. 13 shows a case that an odd number of taps has been formed and generated pixels having the same pixel positions as those of original pixels have been generated. Due to increase of pixel values of pixels having pixel positions 1, 5 and 9 and decrease of pixel values of pixels having pixel positions 3, 7 and 11, an amplitude of a whole image data string is increased so that a high frequency component of the sample image shown in FIG. 33 is enhanced. As described above, it is called “a high-frequency enhancement” that the pixel values D2 of the generated pixels are set as values constituting a new image data string whose high frequency component is enhanced as compared with the image data string obtained by the original pixels. Further, it is called “a high frequency enhancing processing” to generate generated pixels with an enhanced high frequency.

On the other hand, the filter coefficients C1, C2, C3 and C4 are set such that a new image data string obtained by generated pixels suppresses a high frequency component of the image data string obtained by the original pixels in the case of reduction processing. That is, the filter coefficients are set such that the pixel values D2 of the generated pixels with the suppressed high frequency explained in the first embodiment are obtained.

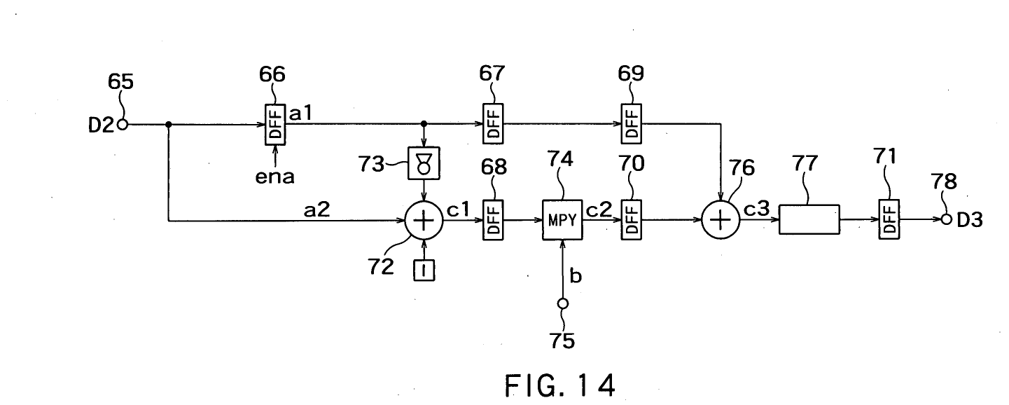

Next, a specific constitution of the linear interpolation filter 63 will be explained with reference to FIG. 14. FIG. 14 is a circuit diagram showing a configuration of the linear interpolation filter 63 in the image processing apparatus according to this embodiment.

The pixel values D2 of the generated pixels outputted from the output terminal 41 of the pre-filter 2 is inputted into the input terminal 65.

A register 66 is a D type flip-flop with Enable, and it holds at its output a pixel value D2 of the generated pixel inputted before one pixel to a generated pixel inputted from the input terminal 65 due to control on Enable performed by the control circuit 4.

Registers 67 to 71 are D type flip-flops for updating output data for each one clock.

An adder 72 adds a complement pixel value generated by bit-inverting output data a1 of the register 66 in an inverter 73, a pixel value a2 of the generated pixel inputted from the input terminal 65, and a value 1 to calculate a difference c1(=(a2−a1)) between a pixel value a2 of the generated pixel and the output data a1 of the register 66.

A multiplier 74 is inputted with a multiplication coefficient b corresponding to the phase of an interpolation pixel from the control circuit 4 via an input terminal 75, and it calculates a multiplication result c2(=b×(a2−a1).

An adder 76 is inputted with the multiplication result c2(=b×(a2−a1) and the output data a1 of the register 66 via the registers 70 and 69, and it calculates an operation result c3(=a1+b×(a2−a1)). When the operation result c3(=a1+b×(a2−a1)) is expressed in another manner, it is expressed as (a1×(1−b)+a2×b). A linear interpolation data corresponding to the phase of the interpolation pixel is generated according to this operation.

An amplitude restricting unit 77 rounds the linear interpolation data, and further restricting the pixel values of the pixels within the maximum amplitude (0 to 255) to output them via the register 71 and the output terminal 78. Then, the output data becomes the pixel values D3 of the interpolation pixels constituting the image data of the size-converted image.

Further, the amplitude restricting unit 77 is provided at a rear stage of the adder 76, and it is constituted so as not to amplitude-restrict the pixel values D2 of the generated pixels but to amplitude-restrict the linear interpolation data. In the case that the pixel values D2 of the generated pixels with an enhanced high frequency is amplitude-restricted before they are used for calculation of the interpolation pixels, and the linear interpolation is performed on the basis of the pixel values of the generated pixels amplitude-restricted, the number of reference pixels used for the linear interpolation must be increased (because a convolution operation based on values of many proximity pixels is required). Therefore, it is desirable like this embodiment that the pixel values D2 of the generated pixels with enhanced high frequency is not amplitude-restricted before they are used for calculation of the interpolation pixels.

A graph representing pixel values of an image where the number of pixels on the sample image shown in FIG. 33 has been enlargement-processed to 2.5 times according to the image processing apparatus according to this embodiment is shown in FIG. 15. In FIG. 15, a horizontal axis shows, for example, pixel positions of respective pixels arranged adjacent to one another in a horizontal direction, and a vertical axis shows pixel values of the respective pixels. Further, a pixel (displayed as A in FIG. 33) at a pixel position 5 in the sample image shown in FIG. 33 corresponds to the pixel (displayed as A in FIG. 15) at a pixel position 11 in the image which has been subjected to the enlargement processing in FIG. 15. Incidentally, the pixel position here is indicated by one of serial numbers attached to respective pixels arranged adjacent to one another in a horizontal direction in an image which has been subjected to an enlargement processing. In the image which has been subjected to an enlargement processing by the image processing apparatus according to this embodiment, its high frequency component is not lost even by the enlargement processing and a false contour due to non-continuous change of pixel values of pixels does not occur, which is different from an image which has been subjected to an enlargement processing by the conventional linear interpolation/nearest neighbor interpolation switching method shown in FIG. 34.

As described above, the image processing apparatus according to this embodiment generates a generated pixel which has been subjected to a high-frequency enhancement in the enlargement processing to perform pixel interpolation by the linear interpolation method utilizing the generated pixel which has been subjected to the high-frequency enhancement as reference pixels. For this reason, the image processing apparatus according to this embodiment can achieve the same advantage as the first embodiment in the enlargement processing.

Further, the image processing apparatus according to this embodiment suppresses the high frequency component of an image by generating the generated pixels which have been subjected to the high-frequency restriction in the reduction processing like the first embodiment. Therefore, this embodiment can achieve the same advantage as the first embodiment even in the reduction processing.

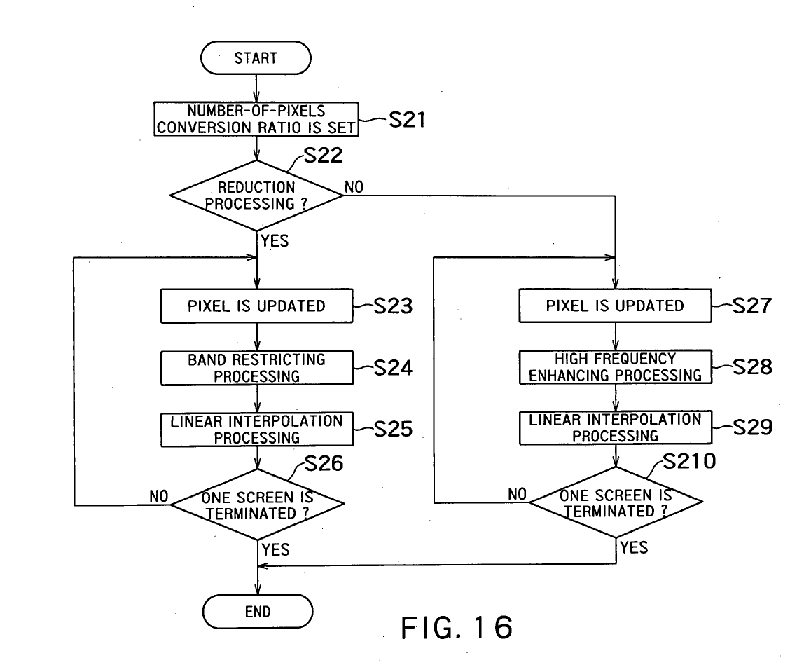

Next, the image processing method according to this embodiment will be explained with reference to FIG. 16.

FIG. 16 shows a flowchart showing a procedure of the image processing method according to this embodiment. Incidentally, in the image processing method according to this embodiment, the high-frequency correcting processing (Step S18 in FIG. 10) explained with reference to FIG. 10 in the explanation about the first embodiment has been replaced with a high frequency enhancing processing (Step S28) and the remaining steps are identical to the steps in the first embodiment.

Therefore, explanation about steps common to those in the image processing method according to the first embodiment will be omitted in this embodiment.

When determination is made in Step S22 that the image conversion processing is not a reduction processing (when determination is made that the processing is an enlargement processing), the image data string stored in the buffer memory 1 is updated (S27) and a high frequency enhancing processing is performed using the pixel values D1 of the original pixels read out from the buffer memory 1 so that the pixel values D2 of the generated pixels with enhanced high frequency are calculated (S28). Next, a linear interpolation processing is performed using the pixel values D2 of the generated pixels with an enhanced high frequency, so that pixel values D3 of interpolation pixels are calculated (S29). After the linear interpolation processing has been terminated, determination is made whether or not a processing of pixels corresponding to one screen has been terminated. When negative determination is made, the control returns back to Step S27, where the above-described Steps S27 to S29 are repeated until the processing for the one screen has been terminated (S210).

The image processing method according to this embodiment explained above generates generated pixels which have been subjected to a frequency enhancement in the enlargement processing of an image to perform pixel interpolation by the linear interpolation method using the generated pixels which have been subjected to the high-frequency enhancement as the reference pixels. Further, the image processing method according to this embodiment suppresses a high frequency component in an image by generating generated pixels which have been subjected to the high-frequency restriction in the reduction processing. For this reason, the image processing method according to this embodiment can achieve a similar advantage to that in the first embodiment.

Incidentally, in explanation of the image processing apparatus according to this embodiment, the specific circuit configurations of the pre-filter 62 and the linear interpolation filter 63 have been shown like the first embodiment, but circuit configurations of these filters are not limited to these specific configurations. For example, pre-filter 62 may determine the number of original pixels which is referenced for a convolution operation according to a control parameter (for example a pixel number conversion ratio) from the control circuit 4. In addition, the image processing apparatus according to this embodiment performs the linear interpolation using two pixels as reference pixels, but this invention is not limited to this linear interpolation. In addition, the image processing apparatus according to this embodiment performs the linear interpolation using two pixels as reference pixels, but this invention is not limited to this linear interpolation like the first embodiment. In this invention, a linear interpolation may be performed using three or more pixels as reference pixels.

Moreover, the respective constituent elements (the buffer memory 1, the pre-filter 62, the linear interpolation filter 63 and the control circuit 4) in the image processing apparatus according to this embodiment may be all provided on the same semiconductor chip like the first embodiment, some or all of these elements may be provided independently from other constituent element.

Further, the image processing apparatus and the image processing method according to this embodiment performs the line interpolation in the reduction processing, but the linear interpolation processing is not an essential processing for this invention like the first embodiment. An advantage similar to that in the case that the linear interpolation has been performed can be obtained even by extracting generated pixels which have been subjected to a high-frequency restriction at fixed intervals to constitute a new image without performing the linear interpolation.

Furthermore, in the image processing apparatus and the image processing method according to this embodiment, the case that the size conversion of an image in the horizontal direction is performed as one example has been explained, but this invention is not limited to this case like the first embodiment. An advantage similar to the case that the size conversion in the horizontal direction has been performed can be obtained even in the case that a size conversion is performed in such another direction as a vertical direction.

In the image processing apparatus and the image processing method according to this embodiment, also, only the explanation about the size conversion in a one-dimensional direction (a horizontal direction) has been made. However, for example, size conversion in a two-dimensional direction can be performed by, after performing a size conversion in a horizontal direction, performing a similar size conversion to a vertical direction utilizing the image which has been subjected to the size conversion in the horizontal direction as an original image like the first embodiment. In this connection, such a constitution can be employed that, after a size conversion corresponding to one screen in one direction of a horizontal direction and a vertical direction has been terminated, a size conversion in the other direction is performed, or a size conversion corresponding to one screen is performed by extracting an image occupying a rectangular region of predetermined size and performing size conversion of the extracted image in a horizontal direction and in a vertical direction, and repeating extraction and size conversion of such an image.

(Third Embodiment)

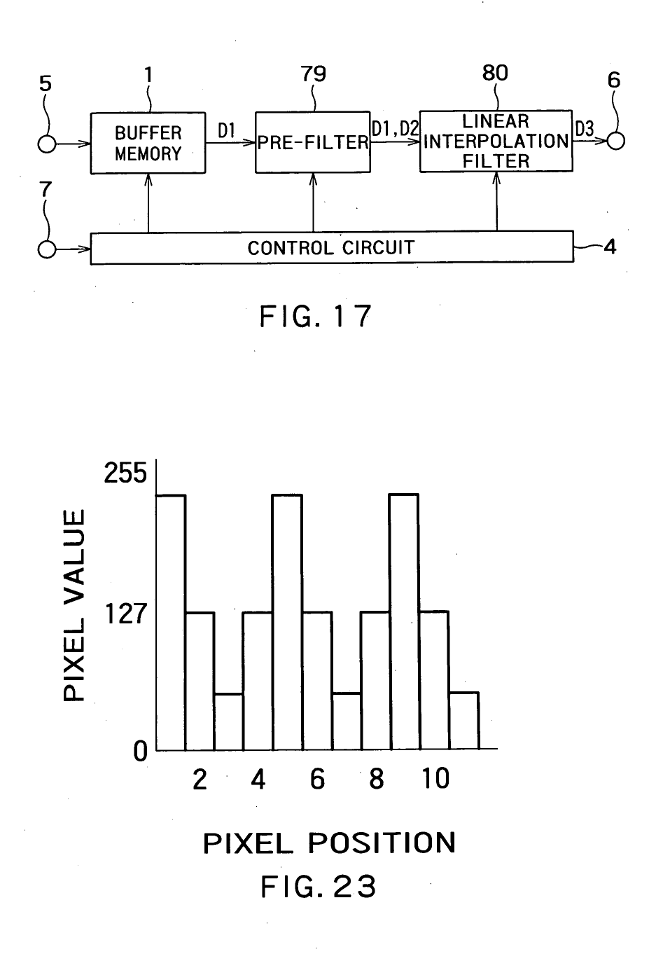

A third embodiment about an image processing apparatus and an image processing method according to the present invention will be explained with reference to FIGS. 17 to 20.

First, the image processing apparatus according to this embodiment will be explained with reference to FIGS. 17 to 19.

FIG. 17 is a block diagram showing a configuration of the image processing apparatus according to this embodiment.

In this connection, parts and/or portions common to those in the first embodiment explained with reference to FIG. 1 are attached with same reference numerals in FIG. 1, and explanation thereof will be omitted. As shown in FIG. 17, the image processing apparatus according to this embodiment is provided with a buffer memory 1, a pre-filter 79 which is a first filter, a linear interpolation filter 80 which is a second filter, and a control circuit 4.

The pre-filter 79 calculates pixel values D2 of generated pixels which have been subjected to the high-frequency correction or the high-frequency enhancement in the case of an enlargement processing and it calculates pixel values D2 of generated pixels which have been subjected to the high-frequency restriction in the case of reduction processing on the basis of the image data string inputted from the buffer memory 1. The high-frequency correction, the high-frequency enhancement and the high-frequency restriction are the same as those explained in the first and second embodiments.

The linear interpolation filter 80 is inputted with pixel values D1 of original pixels and pixel values D2 of generated pixels from the pre-filter 79. The linear interpolation filter 80 calculates pixel values D3 of interpolation pixels according to the linear interpolation method by using the original pixels and the generated pixels as reference pixels in the case that the generated pixels are ones which have been subjected to the high-frequency correction, and it calculates pixel values D3 of interpolation pixels according to the linear interpolation method by using two adjacent ones of generated pixels as reference pixels in the case that the generated pixels are ones which have been subjected to the high-frequency enhancement or the high-frequency restriction. The pixel values D3 of the interpolation pixels are outputted to the output terminal 6.

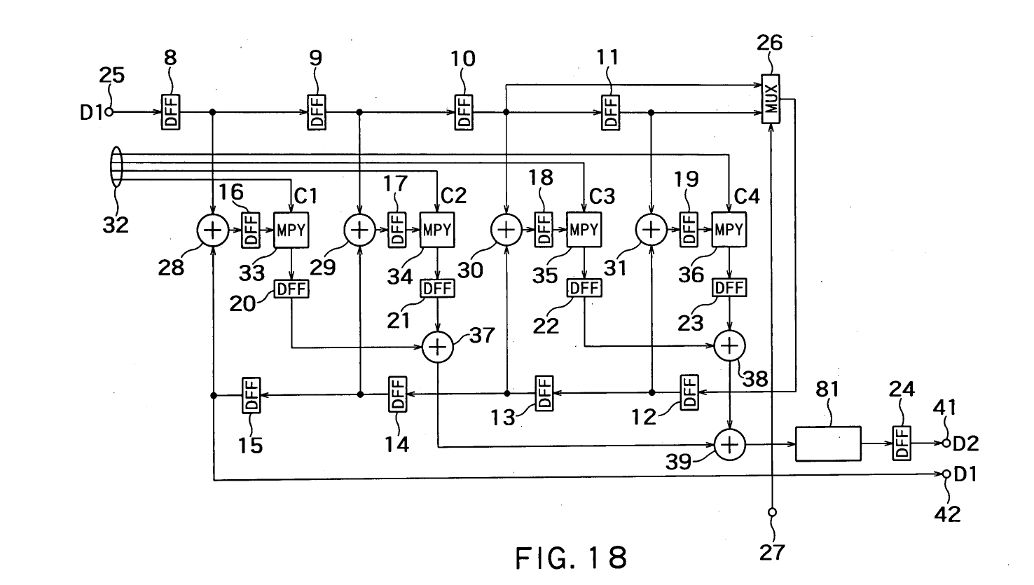

Next, a specific configuration of the pre-filter 79 in the image processing apparatus according to this embodiment will be explained with reference to FIG. 18. FIG. 18 is a circuit diagram showing a configuration of the pre-filter 79 in the image processing apparatus according to this embodiment. Incidentally, parts or portions common to those in the first embodiment explained with reference to FIG. 2 are attached with same reference numerals as those in FIG. 2, and explanation thereof will be omitted.

A rounding unit 81 performs rounding on the result of a convolution operation outputted from the adder 39 to output the same to an output terminal 41 via the register 24 without limitation of the pixel values of the pixels within the maximum amplitude (0 to 255). Then, the pixel values outputted from the output terminal 41 become pixel values D2 of generated pixels.

Further, the filter coefficients C1, C2, C3 and C4 used for a convolution operation are set such that the pixel values D2 of the generated pixels are subjected to either one of high-frequency correction and high-frequency enhancement in the case of an enlargement processing and they are set such that the pixel values D2 of the generated pixels are subjected to high-frequency restriction in the case of a reduction processing.

Further, in the case that the high-frequency correction is performed at the time of an enlargement processing, the selector 26 is caused to select output data of the register 11 to form an even number of taps. On the other hand, in the case that the high-frequency enhancement is performed at the time of an enlargement processing, or at the time of the reduction processing, either one of an even number of taps and an odd number of taps may be formed.

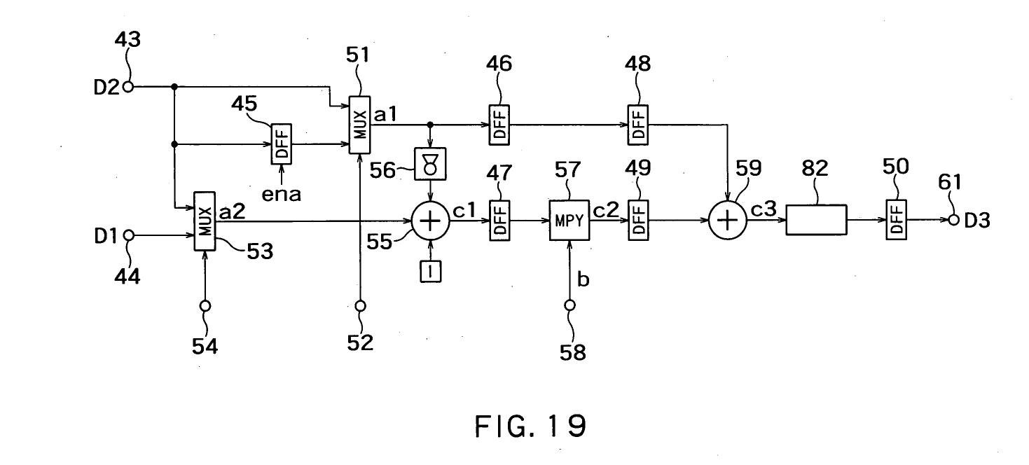

Next, a specific configuration of the linear interpolation filter 80 will be explained with reference to FIG. 19. FIG. 19 is a circuit diagram showing a configuration of the linear interpolation filter 80 in the image processing apparatus according to this embodiment. Incidentally, parts and/or portions common to those in the first embodiments explained with reference to FIG. 3 are attached with same reference numerals in FIG. 3, and explanation thereof will be omitted.

In the case that the pre-filter 79 has performed the high-frequency correction at the time of the enlargement processing, the selector 53 selects the pixel values D1 of the original pixels inputted from the input terminal 44. On the other hand, when the pre-filter 79 has performed the high-frequency enhancement at the time of enlargement processing, or at the time of the reduction processing, the selector 53 selects the pixel values D2 of the generated pixels inputted from the input terminal 43. Thereby, in the case that the high-frequency correction has been performed at the time of the enlargement processing, the pixel values D3 of the interpolation pixels are calculated according to the linear interpolation method by using the generated pixels and the original pixels as reference pixels. In the case that the high-frequency enhancement has been performed at the time of the enlargement processing, or at the time of the reduction processing, the pixel values D3 of the interpolation pixels are calculated according to the linear interpolation method by using two generated pixels whose pixel positions are adjacent to each other as the reference pixels.

An amplitude restricting unit 82 rounds the linear interpolation data outputted from the adder 59, and further restricting the pixel values of the pixels within the maximum amplitude (0 to 255) to output them via the register 50 and the output terminal 61. Then, the output data becomes the pixel values D3 of the interpolation pixels constituting the image data of the size-converted image.

Further, the amplitude restricting unit 82 is provided at a rear stage of the adder 59, and it is constituted so as not to amplitude-restrict the pixel values D2 of the generated pixels but to amplitude-restrict the linear interpolation data. In the case that the pixel values D2 of the generated pixels with an enhanced high frequency is amplitude-restricted before they are used for calculation of the interpolation pixels, and the linear interpolation is performed on the basis of the pixel values of the generated pixels amplitude-restricted, the number of reference pixels used for the linear interpolation must be increased (because a convolution operation based on values of many proximity pixels is required). Therefore, it is desirable like this embodiment that the pixel values D2 of the generated pixels with enhanced high frequency is not amplitude-restricted before they are used for calculation of the interpolation pixels.

The image processing apparatus according to this embodiment explained above generates the generated pixels which have been subjected to the high-frequency correction or the high-frequency enhancement in the enlargement processing for an image to perform pixel interpolation according to the linear interpolation method by using the generated pixels and the original pixels, or the generated pixels as the reference pixels. For this reason, the image processing apparatus according to this embodiment can achieve an advantage similar to those in the first and second embodiments in the enlargement processing.

Further, the image processing apparatus according to this embodiment can arbitrarily make determination about whether the high-frequency correction or the high-frequency enhancement is performed in the above-described enlargement processing by selecting the filter coefficients used in the convolution operation. Since the number of reference pixels in the linear interpolation is doubled due to the interpolation of the generated pixels to the original pixels, for example by weakening the magnitude of enhancing the high frequency component, the high-frequency correction is particularly suitable for enlargement of a natural image. On the other hand, since the original pixels are not used as the reference pixels for the linear interpolation, the magnitude of enhancing the high frequency component can be increased and the high-frequency enhancement is therefore suitable for enlargement of a text image.

Further, the image processing apparatus according to this embodiment suppresses the high frequency component of an image by generating the generated pixels which have been subjected to the high-frequency restriction in the reduction processing like the first and second embodiments. Therefore, this embodiment can achieve an advantage similar to those in the first and second embodiments even in the reduction processing.

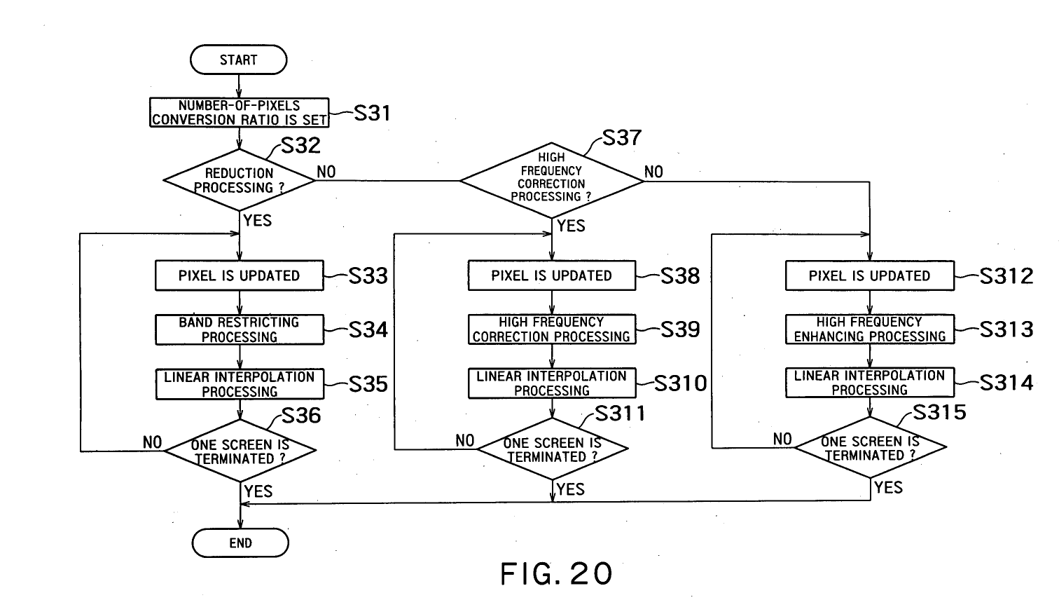

Next, the image processing method according to this embodiment will be explained with reference to FIG. 20.

FIG. 20 is a flowchart showing a procedure of the image processing method according to this embodiment. Incidentally, in the image processing method according to this embodiment, an operator can make selection about whether the high-frequency correcting processing should be performed or the high frequency enhancing processing should be performed in the enlargement processing, and the other steps are identical to those in the first and second embodiments. Therefore, explanation about steps common to those in the image processing methods according to the first and second embodiments will be omitted in this embodiment.

When determination is made in Step S32 that the image size conversion processing is not the reduction processing (when determination is made that the processing is the enlargement processing), successively determination is made about whether or not the high-frequency correcting processing should be performed in the enlargement processing (S37).

In Step S37, when determination is made that the high-frequency correcting processing is performed, a processing similar to the processing from Steps S17 to S110 explained with reference to FIG. 10 in the first embodiment is performed (S38 to S311).

On the other hand, when determination is made in Step S37 that the high-frequency correcting processing is not performed (when determination is made that the high frequency enhancing processing is performed), a processing similar to the processing from Steps S27 to S210 explained with reference to FIG. 16 in the second embodiment is performed (S312 to S315).

The image processing method according to this embodiment explained above generates the generated pixels which have been subjected to the high-frequency correction or the high-frequency enhancement in the enlargement processing for an image to perform pixel interpolation according to the linear interpolation method by using the generated pixels and the original pixels, or the generated pixels as the reference pixels. The image processing method according to this embodiment suppresses the high frequency component in an image by generating the generated pixels which have been subjected to the high-frequency restriction in the reduction processing. Therefore, the image processing method according to this embodiment can obtain an advantage similar to those in the first and second embodiments.

Further, the image processing method according to this embodiment can arbitrarily make determination about the high-frequency correction should be performed or the high-frequency enhancement should be performed in the enlargement processing. For this reason, the enlargement processing can be performed by the optimal method so as to fit an image to be processed.

Incidentally, in explanation of the image processing apparatus according to this embodiment, the specific circuit configurations of the pre-filter 79 and the linear interpolation filter 80 have been shown like the first and second embodiments, but circuit configurations of these filters are not limited to these specific configurations.

Furthermore, the image processing apparatus according to this embodiment performs the linear interpolation using two pixels as reference pixels, but this invention is not limited to this linear interpolation like the first and second embodiments. In this invention, a linear interpolation may be performed using three or more pixels as reference pixels.

Moreover, in the image processing apparatus according to this embodiment, the pixel value D2 of the generated pixel is not subjected to an amplitude restriction before they are used for calculation of the interpolation pixels as the reference pixels, but this invention is not limited to this case. The pixel value D2 of the generated pixel may be subjected to an amplitude restriction before they are used for calculation of the interpolation pixels.

Further, the respective constituent elements (the buffer memory 1, the pre-filter 79, the linear interpolation filter 80 and the control circuit 4) in the image processing apparatus according to this embodiment may be all provided on the same semiconductor chip like the first and second embodiments, some or all of these elements may be provided independently from other constituent element

In addition, in the image processing apparatus and the image processing method according to this embodiment, the generated pixels are interpolated between the original pixels by high-frequency correcting processing so that the number of pixels are doubled. However, the increase rate of the number of pixels is not limited to this double like the first embodiment.

Furthermore, the image processing apparatus and the image processing method according to this embodiment performs the linear interpolation in the reduction processing, but the linear interpolation processing is not an essential processing for this invention like the first and second embodiments. An advantage similar to that in the case that the linear interpolation has been performed can be obtained even by extracting generated pixels which have been subjected to the high-frequency restriction at fixed intervals to constitute a new image without performing the linear interpolation.

Moreover, in the image processing apparatus and the image processing method according to this embodiment, the case that the size conversion of an image in the horizontal direction is performed as one example has been explained, but this invention is not limited to this case like the first and second embodiments. An advantage similar to the case that the size conversion in the horizontal direction has been performed can be obtained even in the case that a size conversion is performed in such another direction as a vertical direction.

Furthermore, in the image processing apparatus and the image processing method according to this embodiment, also, only the explanation about the size conversion in a one-dimensional direction (a horizontal direction) has been made. However, for example, size conversion in a two-dimensional direction can be performed by, after performing a size conversion in a horizontal direction, performing a similar size conversion to a vertical direction utilizing the image which has been subjected to the size conversion in the horizontal direction as an original image like the first and second embodiments. In this connection, such a constitution can be employed that, after a size conversion corresponding to one screen in one direction of a horizontal direction and a vertical direction has been terminated, a size conversion in the other direction is performed, or a size conversion corresponding to one screen is performed by extracting an image occupying a rectangular region of predetermined size and performing size conversion of the extracted image in a horizontal direction and in a vertical direction, and repeating extraction and size conversion of such an image.

(Fourth Embodiment)

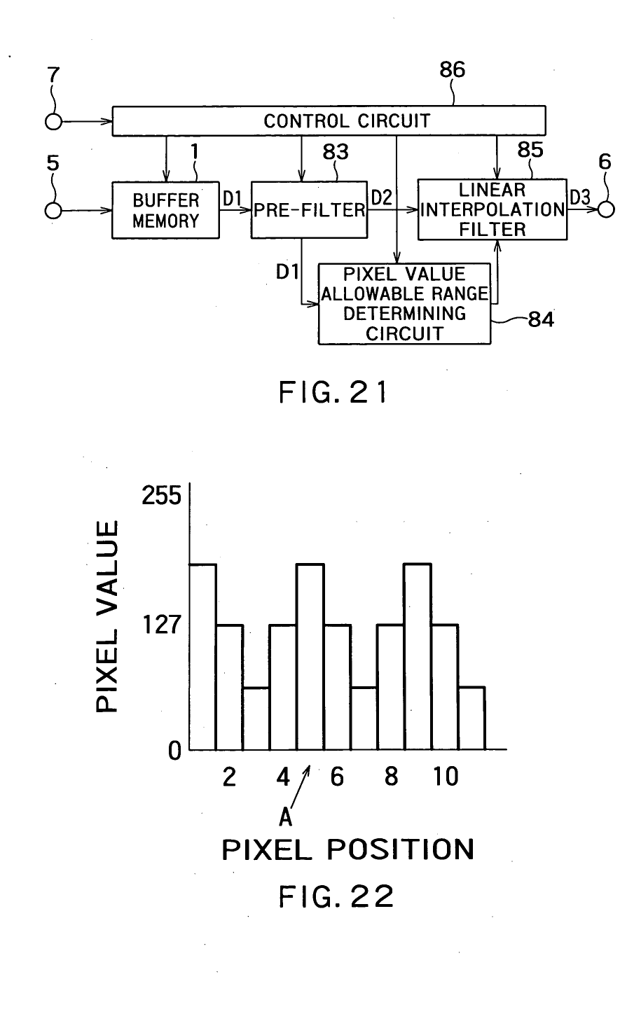

A fourth embodiment about an image processing apparatus and an image processing method according to this invention will be explained with reference to FIGS. 21 to 27.

When a high-frequency enhancement is performed, such an event may occur that the amplitude of the entire image data string is increased excessively due to the filter coefficients C1, C2, C3 and C4 in the pre-filter shown in FIGS. 12 to 18 so that a portion of an original image where change in pixel value is smooth is enhanced excessively in an image which has been subjected to an enlargement processing. The image processing apparatus and the image processing method according to this embodiment is applied for solving the above problem.

First, the image processing apparatus according to this embodiment will be explained with reference to FIGS. 21 to 26.

FIG. 21 is a block diagram showing a configuration of the image processing apparatus according to this embodiment.

Incidentally, parts and/or portions common to those in the first embodiment explained with reference to FIG. 1 are attached with same reference numerals in FIG. 1, and explanation thereof will be omitted. As shown in FIG. 21, the image processing apparatus according to this embodiment is provided with a buffer memory 1, a pre-filter 83 which is a first filter, a pixel value allowable range determining circuit (determining circuit) 84, a linear interpolation filter 85 which is a second filter, and a control circuit 86.

The pre-filter 83 calculates pixel values D2 of generated pixels which have been subjected to the high-frequency enhancement in the case of an enlargement processing and it calculates pixel values D2 of generated pixels which have been subjected to the high-frequency restriction in the case of reduction processing on the basis of the image data string inputted from the buffer memory 1.

The pixel value allowable range determining circuit 84 is inputted with pixel values D1 of original pixels from the pre-filter 83 to calculate an allowable range for pixel values D3 of interpolation pixels using the pixel values D1 of the original pixels. That is, the pixel value allowable range determining circuit 84 calculates an allowable maximum value and an allowable minimum value of the pixel values D3 of the interpolation pixels using the pixel values D1 of the original pixels.

The linear interpolation filter 85 is inputted with pixel values D2 of generated pixels from the pre-filter 83 to calculate the pixel value D3 of the interpolation pixel according to the linear interpolation method by using two adjacent ones of generated pixels as the reference pixels. Here, the pixel value D3 of the interpolation pixel is amplitude-restricted within the allowable range (a range from the allowable minimum value to the allowable maximum value) for the pixel values D3 of the interpolation pixels calculated by the pixel value allowable range determining circuit 84. That is, the linear interpolation data calculated according to the linear interpolation using the two generated pixels as the reference pixels is a value within the allowable range, the linear interpolation data is set to the pixel value D3 of the interpolation pixel. On the other hand, when the linear interpolation data is larger than the allowable maximum value, the allowable maximum value is set to the pixel value D3 of the interpolation pixel. When the linear interpolation data is smaller than the allowable minimum value, the allowable minimum value is set to the pixel value D3 of the interpolation pixel. The pixel value D3 of the interpolation pixel amplitude-restricted to the allowable range is outputted to the output terminal 6.

The control circuit 86 controls the buffer memory 1, the pre-filter 83, the pixel value allowable range determining circuit 84 and the linear interpolation filter 85 according to the pixel number conversion rate.

Next, a specific configuration of the pre-filter 83 in the image processing apparatus according to this embodiment will be explained.

The specific configuration of the pre-filter 83 is identical to one explained with reference to FIG. 18 in the third embodiment. Incidentally, in the third embodiment, the filter coefficients C1, C2, C3 and C4 are set such that either processing of the high-frequency correction and the high-frequency enhancement is performed at the time of an enlargement processing. On the other hand, in this embodiment, the filter coefficients C1, C2, C3 and C4 are set such that the high frequency enhancing processing is performed at the time of an enlargement processing.

A graph representing pixel values of generated pixels calculated by the pre-filter 83 on the basis of the sample image shown in FIG. 22 is shown in FIG. 23. In FIGS. 22 and 23, a horizontal axis shows, for example, pixel positions of respective pixels arranged adjacent to one another in a horizontal direction, and a vertical axis shows pixel values of respective pixels. Here, the pixel positions represent numbers attached to respective pixels arranged adjacent to one another in a horizontal direction in an image.

The pixel values of the pixels having the pixel positions 1, 5 and 9 increase and the pixel values of the pixels having the pixel positions 3, 7 and 11 decrease in the sample image shown in FIG. 22 so that the amplitude of the entire image data string obtained by the generated pixels shown in FIG. 23 is increased as compared with that of the sample image and the high frequency component is enhanced.

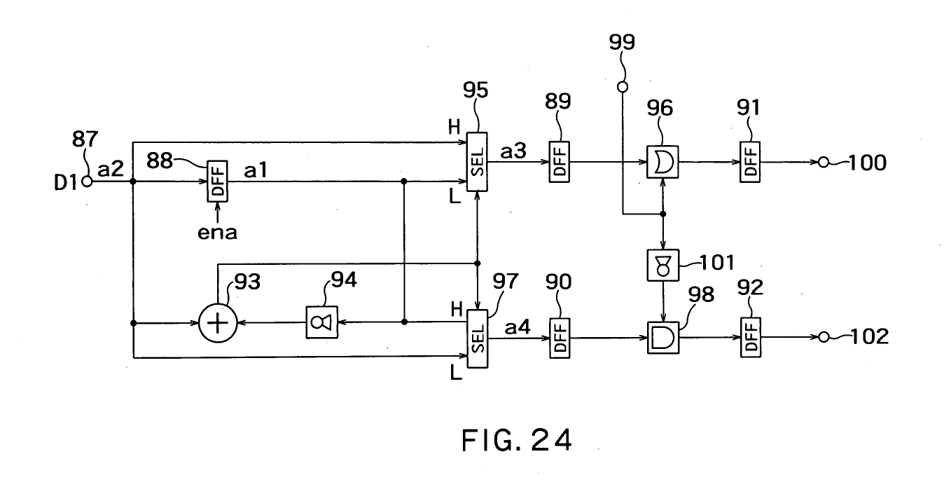

Next, a specific configuration of the pixel value allowable range determining circuit 84 in the image processing apparatus according to this embodiment will be explained with reference to FIG. 24. FIG. 24 is a circuit diagram showing a configuration of the pixel value allowable range determining circuit 84 in the image processing apparatus according to this embodiment.

An input terminal 87 is inputted with the pixel values D1 of original pixels via the pre-filter 83.

A register 88 is a D type flip-flop with Enable, and its Enable is controlled by the control circuit 86 so that a pixel value D1 of a original pixel inputted before one pixel to another original pixel inputted from the input terminal 87 is held at its output.

Registers 89 to 92 are D type flip-flops for updating output data for each one clock.

An adder 93 adds a compliment pixel value generated by bit-inverting output data a1 of the register 88 in a inverter 94 and a pixel value a2 of a original pixel inputted from the input terminal 87. When the pixel value a2 of the original pixel inputted from the input terminal 87 is larger than the output data a1 of the register 88, a carry is outputted from the adder 93.

A selector 95 selects a larger one of the output data a1 of the register 88 and the pixel value a2 of the original pixel inputted from the input terminal 87 on the basis of the carry from the adder 93 to output the same. The data a3 selected by the selector 95 is inputted into an OR circuit 96 via the register 89.

The selector 97 selects a smaller one of the output data a1 of the register 88 and the pixel value a2 of the original pixel inputted from the input terminal 87 on the basis of the carry from the adder 93 to output the same. The data a4 selected by the selector 97 is inputted into an AND circuit 98 via the register 90.

The OR circuit 96 outputs the maximum value (255) according to a control signal inputted from the control circuit 86 via an input terminal 99 irrespective of the value of the output data a3 of the selector 95, when an amplitude restriction of the pixel value D3 of the interpolation pixel is not required in such a processing as a reduction processing. On the other hand, when an amplitude restriction of the pixel value D3 of the interpolation pixel is required in such a processing as an enlargement processing, the OR circuit 96 outputs the output data a3 of the selector 95. The output data of the OR circuit 96 is outputted to an output terminal 100 via the register 91.

The output data from the output terminal 100 becomes the allowable maximum value of the pixel value D3 of the interpolation pixel.

The AND circuit 98 output the minimum value (0) according to a signal obtained by bit-inverting a control signal from the control circuit 86 in an inverter 101 irrespective of the value of the output data a4 of the selector 97, when the amplitude restriction of the pixel value D3 of the interpolation pixel is not required in such a processing as a reduction processing. On the other hand, when the amplitude restriction of the pixel value D3 of the interpolation pixel is required in such a processing as an enlargement processing, the AND circuit 98 outputs the output data a4 of the selector 97. The output data of the AND circuit 98 is outputted into an output terminal 102 via the register 92. The output data from the output terminal 102 becomes the allowable minimum value of the pixel value D3 of the interpolation pixel.

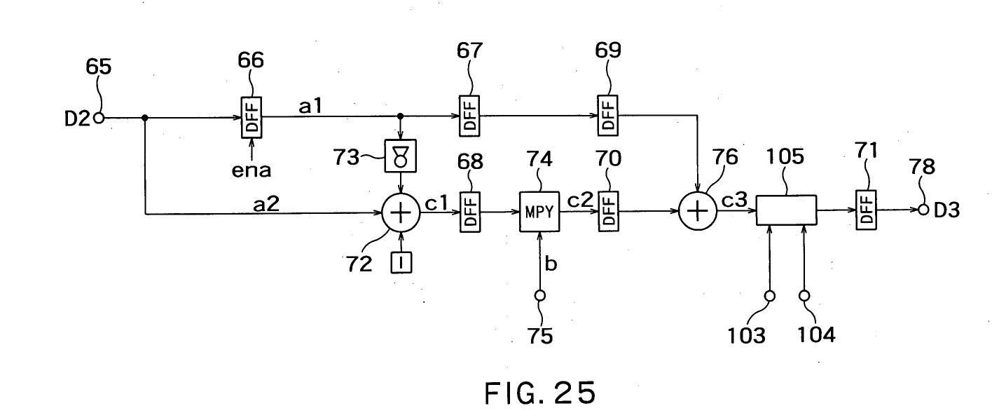

Next, a specific configuration of the linear interpolation filter 85 will be explained with reference to FIG. 25. FIG. 25 is a circuit diagram showing a configuration of the linear interpolation filter 85 in the image processing apparatus according to this embodiment. Incidentally, parts and/or portions common to those in the second embodiment explained with reference to FIG. 14 are attached with same reference numerals in FIG. 14, and explanation thereof will be omitted.

An input terminal 103 is inputted with the allowable maximum value outputted from the output terminal 100 of the determining circuit 84. Further, an input terminal 104 is inputted with the allowable minimum value outputted from the output terminal 102 of the determining circuit 84.

An amplitude restricting unit 105 is inputted with the allowable maximum value and the allowable minimum value via the input terminals 103 and 104 to restrict the linear interpolation data outputted from the adder 76 to a value within the allowable range (the range from the allowable minimum value to the allowable maximum value). That is, when the linear interpolation data is equal to or more than the allowable maximum value, the amplitude restricting unit 105 sets the value of the linear interpolation data to the same value as the allowable maximum value, and when the linear interpolation data is equal to or smaller than the allowable minimum value, it sets the value of the linear interpolation data to the same value as the allowable minimum value. The linear interpolation data which has been amplitude-restricted by the amplitude restricting unit 105 is outputted from the output terminal 78 via the register 71. Then, the output data from the output terminal 78 becomes the pixel values D3 of the interpolation pixels constituting image data which has been size-converted.

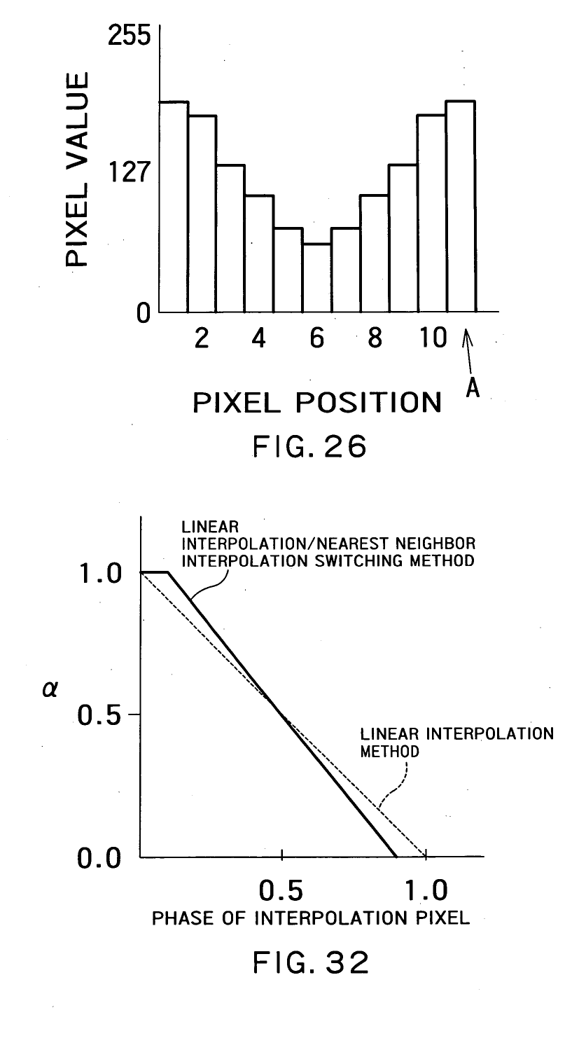

A graph representing pixel values in an image obtained by performing a linear interpolation processing by the linear interpolation filter 85 using pixel values of generated pixels shown in FIG. 23 and performing an enlargement processing to 2.5 times on the sample image shown in FIG. 22 is shown in FIG. 26. In FIG. 26, a horizontal axis shows, for example, pixel positions of respective pixels arranged adjacent to one another in a horizontal direction, and a vertical axis shows pixel values of respective pixels. Here, the pixel positions herein represent numbers attached to respective pixels arranged adjacent to one another in a horizontal direction in an image. A pixel (displayed as A in FIG. 22) with a pixel position 5 in the sample image shown in FIG. 22 corresponds to a pixel (displayed as A in FIG. 26) with a pixel position 11 in the image which has been subjected to an enlargement processing in FIG. 26.

When a linear interpolation is performed using generated pixels shown in FIG. 23 as reference pixels, the amplitude of the image data string obtained becomes larger than the amplitude of the image data string in the sample image shown in FIG. 22. However, for example, in a linear interpolation performed using the generated pixel with a pixel position 1 and the generated pixel with a pixel position 2 as the reference pixels in FIG. 23, the pixel value of the original pixel with the pixel position 1 becomes the allowable maximum value and the pixel value of the original pixel with the pixel position 2 becomes the allowable minimum value in the sample image shown in FIG. 22. For this reason, when the linear interpolation data obtained by the linear interpolation is larger than the pixel value of the original pixel with the pixel position 1, the pixel value D3 of the interpolation pixel is set as the pixel value of the original pixel with the pixel position 1, and when the linear interpolation data is smaller than the pixel value of the original pixel with the pixel position 2, the pixel value D3 of the interpolation pixel is set as the pixel value of the original pixel with the pixel position 2. Thereby, the amplitude of the image data string in the enlargement-processed image shown in FIG. 26 converges within the range of the amplitude of the image data string in the sample image shown in FIG. 22. Further, in the enlargement-processed image shown in FIG. 26, its high frequency component is not lost even by the enlargement processing and a false contour due to non-continuous change of pixel values of pixels does not occur, which is different from an image which has been enlargement-processed by the conventional linear interpolation/nearest neighbor interpolation switching method.

The image processing apparatus according to this embodiment explained above determines the allowable range of the pixel values D3 of the interpolation pixels using the pixel values D1 of the original pixels by the pixel value allowable range determining circuit 84 to generate the pixel values D3 of the interpolation pixels amplitude-restricted to the determined allowable range in the enlargement processing of the image. For this reason, in the image processing apparatus according to this embodiment, the high frequency component in the original image is prevented from being enhanced excessively regardless of the values of the filter coefficients C1, C2, C3 and C4. Therefore, the image processing apparatus according to this embodiment can change the number of pixels in an image while maintaining the state of an original image regardless of the filter coefficients of the pre-filter.

As regard the other advantages, also, the image processing apparatus according to this embodiment can achieve advantages similar to those in the first to third embodiments.

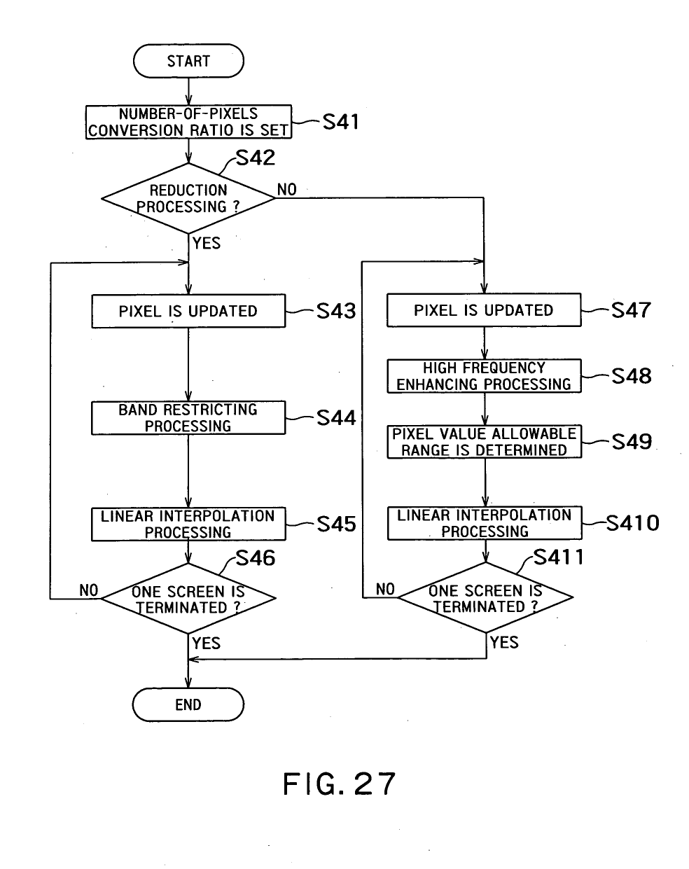

Next, the image processing method according to this embodiment will be explained with reference to FIG. 27.

FIG. 27 is a flowchart showing a procedure of the image processing method according to this embodiment. Incidentally, in the image processing method according to this embodiment, a step of determining the allowable range of the pixel values D3 of the interpolation pixels is added to the image processing method according to the second embodiment explained with reference to FIG. 16, and the other steps are identical to those in the second embodiment. Therefore, explanation about steps common to those in the image processing method according to the second embodiment will be omitted here.

After a high frequency enhancing processing (S48) has been performed, an allowable range for pixel values D3 of interpolation pixels is determined (S49). In this Step S49, a larger pixel value of the pixel values of two original pixels whose pixel positions are adjacent to each other is set to the allowable maximum value, and a smaller pixel value thereof is set to the allowable minimum value.

Next, a linear interpolation processing is performed using the pixel values D2 of the generated pixels which have been subjected to the high-frequency enhancement to calculate the pixel value D3 of the interpolation pixel which has been amplitude-restricted to the allowable range determined in Step S49 (S410). In this Step S410, when the linear interpolation data obtained by the linear interpolation using the generated pixels as the reference pixels is a value out of the allowable range determined in Step S49, the amplitude restriction of the linear interpolation data is performed such that the pixel value D3 of the interpolation pixel is a value within the allowable range. Specifically, when the linear interpolation data is within the allowable range, the linear interpolation data is set as the pixel value D3 of the interpolation pixel. On the other hand, when the linear interpolation data is a value equal to or more than the allowable maximum value, the allowable maximum value is set as the pixel value D3 of the interpolation pixel, but when the linear interpolation data is a value equal to or smaller than the allowable minimum value, the allowable minimum value is set as the pixel value D3 of the interpolation pixel.

The image processing method according to this embodiment explained above amplitude-restricts the pixel value D3 of the interpolation pixel obtained by the linear interpolation to the allowable range determined using the pixel values D1 of the original pixels in the enlargement processing of the image, after the linear interpolation method has been performed using the generated pixels as the reference pixels. For this reason, in the image processing method according to this embodiment, the high frequency component in the original image is prevented from being excessively enhanced. Therefore, the image processing method according to this embodiment can change the number of pixels in an image regardless of the values of the filter coefficients of the pre-filter while maintaining the state of an original image.

In this connection, in explanation of the image processing apparatus according to this embodiment, the specific circuit configurations of the pixel value allowable range determining circuit 84 and the linear interpolation filter 85 have been shown, but they are not limited to these specific circuit configurations.

Incidentally, the image processing apparatus according to this embodiment performs the linear interpolation using two pixels as reference pixels, but this invention is not limited to this linear interpolation like the first to third embodiments. In this invention, a linear interpolation may be performed using three or more pixels as reference pixels.

Moreover, the respective constituent elements (the buffer memory 1, the pre-filter 83, the pixel value allowable range determining circuit 84, the linear interpolation filter 85 and the control circuit 86) in the image processing apparatus according to this embodiment may be all provided on the same semiconductor chip like the first to third embodiments, some or all of these elements may be provided independently from other constituent element

Further, the image processing apparatus and the image processing method according to this embodiment performs the linear interpolation in the reduction processing, but the linear interpolation processing is not an essential processing for this invention like the first to third embodiments. An advantage similar to that in the case that the linear interpolation has been performed can be obtained even by extracting generated pixels which have been subjected to the high-frequency restriction at fixed intervals to constitute a new image without performing the linear interpolation.

Moreover, in the image processing apparatus and the image processing method according to this embodiment, the case that the size conversion of an image in the horizontal direction is performed as one example has been explained, but this invention is not limited to this case like the first to third embodiments. An advantage similar to the case that the size conversion in the horizontal direction has been performed can be obtained even in the case that a size conversion is performed in such another direction as a vertical direction.

Furthermore, in the image processing apparatus and the image processing method according to this embodiment, also, only the explanation about the size conversion in a one-dimensional direction (a horizontal direction) has been made. However, for example, size conversion in a two-dimensional direction can be performed by, after performing a size conversion in a horizontal direction, performing a similar size conversion to a vertical direction utilizing the image which has been subjected to the size conversion in the horizontal direction as an original image like the first to third embodiments. In this connection, such a constitution can be employed that, after a size conversion corresponding to one screen in one direction of a horizontal direction and a vertical direction has been terminated, a size conversion in the other direction is performed, or a size conversion corresponding to one screen is performed by extracting an image occupying a rectangular region of predetermined size, performing size conversion of the extracted image in a horizontal direction and in a vertical direction, and repeating extraction and size conversion of such an image.

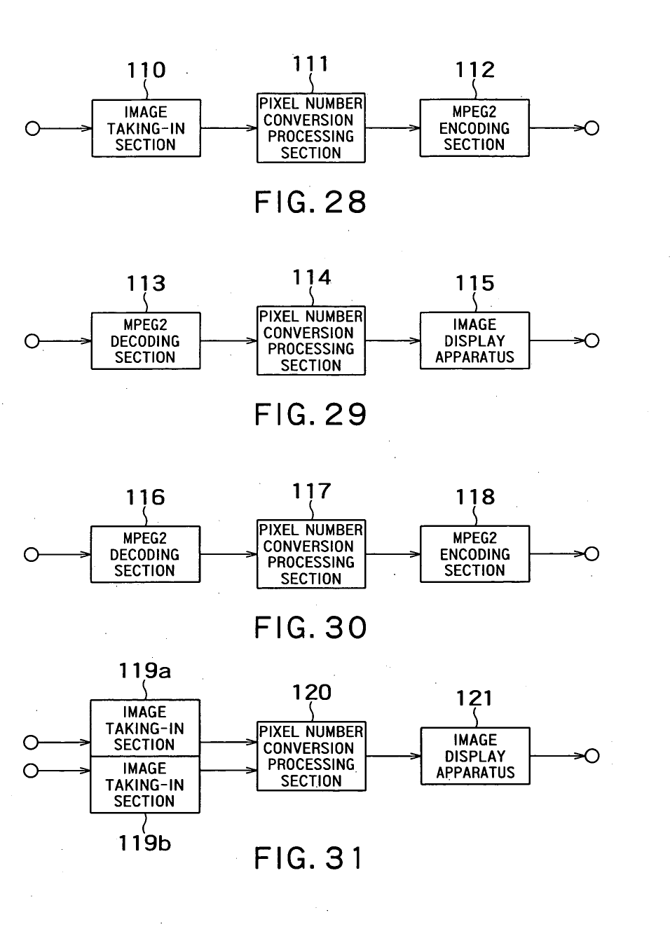

FIG. 28 is a diagram showing an MPEG2 encoding apparatus (an image compressing apparatus) according to a fifth embodiment of the present invention.

An image such as TV signals (a luminance signal and a color difference signal) is taken in a pixel taking-in section (an image data generating section) 110. In an image number conversion processing section 111 according to either one of the first to fourth embodiments of the present invention, the number of pixels in a vertical direction regarding the color difference signal is reduced to ½ and the number of pixels in a horizontal direction about both the luminance signal and the color difference signal is further reduced to ½, ¾ or the like according to a desired encoding rate. Then, in an MPEG2 encoding section 112, the output signal of the pixel number conversion processing section 111 is encoded at a desired encoding rate (an encoding amount) and MPEG2 compressed image data is outputted. In this manner, image encoding with reduced image deterioration can be made by adjusting the number of encoded pixels in the pixel number conversion processing section 111 according to the desired encoding rate.

FIG. 29 is a diagram showing an MPEG2 decoding apparatus (a compressed image elongating apparatus) according to a sixth embodiment of the present invention.

The encoded compressed image data in the same manner as the example shown in FIG. 28 is decoded at an MPEG2 decoder section (the image data generating section) 113. In a pixel number conversion processing section 114 according to either one of the first to fourth embodiments of the present invention, the number of horizontal pixels regarding a luminance signal and a color difference signal is enlarged to two times, 4/3 times or the like and the number of pixels in a vertical direction regarding the color difference signal is further enlarged to two times. A display controller in a display apparatus 115 such as a TV set outputs the image to a display section of the display apparatus 115. By restoring the number of original display pixels in the pixel number conversion processing section 114 according to the encoded image size, image display of an image size with reduced blur or the like is made possible.

FIG. 30 is a diagram showing an MPEG2 encoding rate converting apparatus (a recompressing apparatus) according to a seventh embodiment of the present invention.

An MPEG2 compressed image data encoded so as to have a size that the number of pixels in a vertical direction regarding the color difference signal is reduced to ½ and the number of horizontal pixels regarding the luminance signal and the color difference signal is kept as it is is decoded in an MPEG2 decoding section 116. In a pixel number conversion processing section 117 according to either one of the first to fourth embodiments of the present invention, the numbers of horizontal pixels regarding the luminance signal and the color difference signal in the decoded data are reduced to ½, ¾ or the like according to the desired encoding rate. Then, in an MPEG2 encoder section 118, the output signal of the pixel number conversion processing section 117 is encoded at a desired encoding rate (an encoding amount) and MPEG2 compressed image data is outputted. In this manner, an image encoded with reduced image deterioration can be made by adjusting the number of encoded pixels in the pixel number conversion processing section 117 according to the encoding rate desired due to storage capacity or the like.

FIG. 31 is a diagram showing a TV system having a multi-screen display function according to an eighth embodiment of the present invention.

An image of a main screen and an image of a sub-screen (a child screen) obtained at two or more image taking-in sections 119a and 119b are outputted to a display section 121 by adjusting their number of pixels in a horizontal direction and in a vertical direction in a pixel number conversion processing section 120 according to either one of the first to fourth embodiments of the present invention. Thereby, multi-screen displaying with reduced blurring can be made possible so as to have one of various sizes.

As described above, according to the first to eighth embodiments, an image processing apparatus, an image processing method and an image processing system which can change the number of pixels while maintaining the state of an original image can be provided.

The present invention can be modified variously in its implementing stage within the range of the scope and spirit of the invention.

What is claimed is:

1. An image processing apparatus comprising:
a first filter which is inputted with first image data which includes a plurality of pixels having respective pixel values and whose number of pixels should be converted to enhance or suppress a high frequency component of the inputted first image data to generate intermediate image data; and
a second filter which performs interpolation processing according to a linear interpolation method to the generated intermediate image data to generate second image data whose number of pixels is converted from the first image data.

2. The image processing apparatus according to claim 1, wherein the first filter generates the intermediate image data where the high frequency component of the first image data has been enhanced or suppressed by generating a new pixel having a pixel value between adjacent pixels in the first image data, the pixel value of the new pixel being calculated by a convolution operation of pixel values of pixels positioned near the pixel position where the new pixel should be generated.

3. The image processing apparatus according to claim 2, wherein the first filter is inputted with a pixel number conversion information to determine the number of pixels in the first image data which is referenced for the convolution operation on the basis of the inputted conversion information.

4. The image processing apparatus according to claim 2, wherein the first filer is inputted with a pixel number conversion information to generate intermediate image data where the high frequency component in the first image data has been enhanced in the case of an enlargement processing, and generates intermediate image data where the high frequency component in the first image data has been suppressed in the case of a reduction processing.

5. The image processing apparatus according to claim 1, wherein the first filter generates the intermediate image data where the high frequency component of the first image data has been enhanced or suppressed by generating a new pixel having a pixel value at pixel position of each pixel in the first image data, the pixel value of the new pixel being calculated by a convolution operation of pixel values of pixels positioned near the pixel in the first image data which corresponds to the new pixel.

6. The image processing apparatus according to claim 5, further comprising a determining section to determine an allowable range of each pixel value of interpolation pixels constituting the second image data on the basis of pixel values of pixels in the first image data corresponding to new pixels in the intermediate image data which are referenced for generating the each interpolation pixel by the linear interpolation method,
wherein the second filter restricts the pixel value of the interpolation pixel within the allowable range, in the case where the pixel value of the interpolation pixel exceeds the allowable range as the result of the interpolation processing.

7. The image processing apparatus according to claim 6, where the determining section determines a range defined by the maximum pixel value and the minimum pixel value of the pixels in the first image data corresponding to the new pixels in the intermediate image data as the allowable range.

8. The image processing apparatus according to claim 5, wherein the first filter is inputted with a pixel number conversion information to determine the number of pixels in the first image data which is referenced for the convolution operation on the basis of the inputted conversion information.

9. The image processing apparatus according to claim 5, wherein the first filer is inputted with a pixel number conversion information to generate intermediate image data where the high frequency component in the first image data has been enhanced in the case of an enlargement processing and to generate intermediate image data where the high frequency component in the first image data has been suppressed in the case of a reduction processing.

10. The image processing apparatus according to claim 1, wherein the first filter selectively performs one of
a first processing of generating the intermediate image data where the high frequency component of the first image data has been enhanced or suppressed by generating a new pixel having a pixel value between adjacent pixels in the first image data, the pixel value of the new pixel being calculated by a convolution operation of pixel values of pixels positioned near the pixel position where the new pixel should be generated, and
a second processing of generating the intermediate image data where the high frequency component of the first image data has been enhanced or suppressed by generating a new pixel having a pixel value at pixel position of each pixel in the first image data, the pixel value of the new pixel being calculated by a convolution operation of pixel values of pixels positioned near the pixel in the first image data which corresponds to the new pixel.

11. An image processing method comprising:
a first processing step of being inputted with first image data which includes a plurality of pixels having respective pixel values and whose number of pixels should be converted to enhance or suppress a high frequency component of the inputted first image data to generate intermediate image data; and
a second processing step of performing interpolation processing according to a linear interpolation method to the generated intermediate image data to generate second image data whose number of pixels is converted from the first image data.

12. The image processing method according to claim 11, wherein the first processing step generates the intermediate image data where the high frequency component of the first image data has been enhanced or suppressed by generating a new pixel having a pixel value between adjacent pixels in the first image data, the pixel value of the new pixel being calculated by a convolution operation of pixel values of pixels positioned near the pixel position where the new pixel should be generated.

13. The image processing method according to claim 11, wherein the first processing step generates the intermediate image data where the high frequency component of the first image data has been enhanced or suppressed by generating a new pixel having a pixel value at pixel position of each pixel in the first image data, the pixel value of the new pixel being calculated by a convolution operation of pixel values of pixels positioned near the pixel in the first image data which corresponds to the new pixel.

14. An image processing system comprising:
an image data generating section which generates first image data which includes a plurality of pixels having respective pixel values and whose number of pixels should be converted;
a pixel number conversion section which enhances or suppresses a high frequency component of the inputted first image data to generate intermediate image data and performs interpolation processing according to a linear interpolation method to the generated intermediate image data to generate second image data whose number of pixels is converted from the first image data.; and
an image data processing section which processes the second image data.

15. The image processing system according to claim 14, wherein the pixel number conversion section generates the intermediate image data where the high frequency component of the first image data has been enhanced or suppressed by generating a new pixel having a pixel value between adjacent pixels in the first image data, the pixel value of the new pixel being calculated by a convolution operation of pixel values of pixels positioned near the pixel position where the new pixel should be generated.

16. The image processing system according to claim 14, wherein the pixel number conversion section generates the intermediate image data where the high frequency component of the first image data has been enhanced or suppressed by generating a new pixel having a pixel value at pixel position of each pixel in the first image data, the pixel value of the new pixel being calculated by a convolution operation of pixel values of pixels positioned near the pixel in the first image data which corresponds to the new pixel.

17. The image processing system according to claim 16, wherein the pixel number conversion section determines an allowable range of each pixel value of interpolation pixels constituting the second image data on the basis of pixel values of pixels in the first image data corresponding to new pixels in the intermediate image which are referenced for generating the each interpolation pixel by the linear interpolation method, and restricts the pixel value of the interpolation pixel within the allowable range, in the case where the pixel value of the interpolation pixel exceeds the allowable range as the result of the interpolation processing.

18. The image processing system according to claim 14, wherein the image data processing section includes at least one of an encoding section for encoding the second image data generated by the pixel number conversion section and a display controller for controlling displaying the second image data on a display device.

19. The image processing system according to claim 14, wherein the image data generating section includes at least one of a decoder section for decoding encoded image data and an image taking-in section for taking in image data.
